(19) United States
(12) Patent Application Publication
(10) Pub. No.: US 2026/0227798 A1
(43) Pub. Date: Aug. 6, 2026

(54) DOCKING SYSTEMS AND METHODS FOR AERIAL VEHICLES

(71) Applicant: Amazon Technologies, Inc., Seattle, WA (US)

(72) Inventor: Hsiao-Chieh Yen, Taipei City (TW)

(73) Assignee: Amazon Technologies, Inc., Seattle, WA (US)

(21) Appl. No.: 19/069,885

(22) Filed: Mar. 4, 2025

Related U.S. Application Data
(60) Provisional application No. 63/753,673, filed on Feb. 4, 2025.

(51) Int. Cl. G05D 1/654; B64F 1/18; B64U 70/95; G05D 1/244; G05D 1/43; G05D 1/46; G05D 1/485; G05D 109/20

(52) U.S. Cl. CPC G05D 1/6545; B64F 1/18; B64U 70/95; G05D 1/244; G05D 1/43; G05D 1/46; G05D 1/485; G05D 2109/20

(57) ABSTRACT

Docking systems and methods may comprise an aerial vehicle and a docking station. The aerial vehicle may implement a control strategy during a docking evolution to remain within a safety envelope associated with the docking station, and also to maintain visibility of a landing pad on an upper surface of the docking station. In addition, the control strategy may prioritize descent speed over horizontal positioning as long as the aerial vehicle remains within the safety envelope with visibility of the landing pad. Further, the landing pad may comprise multiple sets of retroreflectors and markers to facilitate performance of the docking evolution.

### CROSS-REFERENCE TO RELATED APPLICATION

This application claims priority to U.S. Application No. 63/753,673, filed Feb. 4, 2025, the contents of which are herein incorporated by reference in their entirety.

### BACKGROUND

Aerial vehicles are most commonly operated in outdoor spaces. When an aerial vehicle operates in an outdoor space, the aerial vehicle may take off from a fixed or mobile location, e.g., a runway, a landing pad, or any like facility or station, by causing motors and propellers to generate lift and elevate the aerial vehicle to a selected altitude or position. The aerial vehicle may then travel on any selected courses, speeds or altitudes. Prior to taking off, or while in flight, an aerial vehicle operating outdoors may determine its position in three-dimensional space using a position sensor, e.g., a Global Positioning System (“GPS”) receiver that captures signals from one or more satellites or other sources, as well as an inertial measurement unit (or “IMU”), one or more altimeters, barometers, or other components. An aerial vehicle may rely on such sensors to travel to a specific location, which may be the same location from which the aerial vehicle took off, or a different location, before completing a landing evolution.

Operating an aerial vehicle, or drone, within indoor spaces presents a unique set of challenges for the aerial vehicle, and creates unique risks for occupants or contents of the indoor spaces. In particular, whereas aerial vehicles that operate outdoors may commonly utilize large, open areas to maneuver during takeoff and landing evolutions, an aerial vehicle that operates indoors, which are often constrained by narrow hallways or other passageways, and feature limited operating areas between floors and ceilings, must usually maneuver and execute takeoff, landing, or docking evolutions with precision.

Furthermore, unlike aerial vehicles that operate within outdoor spaces, which may receive power, connectivity, and other services from systems of any size, shape or location, an aerial vehicle that operates indoors may preferably receive such services from systems that conform to dimensions of the spaces in which the aerial vehicle operates, and are preferably limited in size with respect to the aerial vehicle and any other objects within such spaces.

### BRIEF DESCRIPTION OF THE DRAWINGS

FIG. 1A is a schematic diagram of an example docking system and associated method for aerial vehicles, in accordance with implementations of the present disclosure.

FIG. 1B is a schematic diagram of an example aerial vehicle, in accordance with implementations of the present disclosure.

FIG. 1C is a schematic diagram of an example dock for an aerial vehicle, in accordance with implementations of the present disclosure.

FIG. 1D is a schematic diagram of an example aerial vehicle that is docked with the example dock, in accordance with implementations of the present disclosure.

FIG. 2 is a schematic diagram of an example dock having a landing pad for an aerial vehicle, in accordance with implementations of the present disclosure.

FIG. 3 is a schematic diagram of an example landing pad for a dock of an aerial vehicle, in accordance with implementations of the present disclosure.

FIG. 4 is a flow diagram illustrating an example landing pad detection process, in accordance with implementations of the present disclosure.

FIG. 5 is a schematic diagram of an example docking method for aerial vehicles during a first portion, in accordance with implementations of the present disclosure.

FIG. 6 is a schematic diagram of an example docking method for aerial vehicles during a second portion, in accordance with implementations of the present disclosure.

FIG. 7 is a schematic diagram of an example docking method for aerial vehicles during a third portion, in accordance with implementations of the present disclosure.

FIG. 8 is a schematic diagram of an example docking method for aerial vehicles during a fourth portion, in accordance with implementations of the present disclosure.

FIG. 9 is a flow diagram illustrating an example landing process, in accordance with implementations of the present disclosure.

FIG. 10 is a block diagram illustrating an example system including an aerial vehicle and dock, in accordance with implementations of the present disclosure.

### DETAILED DESCRIPTION

As is set forth in greater detail below, implementations of the present disclosure are directed to docking or landing systems and methods for aerial vehicles, particularly for aerial vehicles that operate within indoor spaces.

In example embodiments, the docking or landing systems described herein may comprise docking stations (or docks) that are configured to receive aerial vehicles on their upper docking or landing surfaces. For example, the docks may comprise landing pads on their upper docking surfaces, and the landing pads may include a plurality of markers, indicia, or other indicators to facilitate detection, descent, and docking of aerial vehicles. In some examples, the landing pads may comprise a plurality of retroreflective markers or indicators. In additional examples, the landing pads may comprise a plurality of markers or indicia, such as AprilTags®, quick response (QR) codes, symbols, characters, or other indicia.

Further, the plurality of markers, indicia, or indicators may be arranged or configured on the landing pads to facilitate detection, positioning, and orientation of aerial vehicles relative to the docks. Moreover, the plurality of markers, indicia, or indicators may be arranged, sized, shaped, or otherwise formed to be detected and utilized during various stages or phases of docking by aerial vehicles. For example, a first set of markers, e.g., the plurality of retroreflective markers, may be arranged, sized, or shaped for detection and utilization by aerial vehicles during an initial stage or phase of docking, e.g., at a greater height or distance from the docks. In addition, one or more sets of indicia, e.g., the plurality of AprilTags®, quick response (QR) codes, symbols, characters, or other indicia, may be arranged, sized, or shaped for detection and utilization by aerial vehicles during one or more subsequent or later stages or phases of docking, e.g., at medium or shorter heights or distances from the docks.

In additional example embodiments, the docks may comprise covers or shields that are configured to protect the landing pads. For example, the covers or shields may comprise sheets, films, or materials that protect against damage or modification to the markers, indicia, or indicators of the landing pads. In addition, the covers or shields may comprise sheets, films, or materials that enable transmission of one or more wavelengths of light, e.g., infrared bandpass protective covers, or other types of covers. Such covers or shields may enable detection of markers, indicia, or other indicators presented by the landing pads responsive to illumination by appropriate wavelengths of light, while also reducing visibility of the landing pads by users or customers utilizing the aerial vehicles and docks. In this manner, the covers or shields may maintain the desired function or operation of the docks and landing pads, while also improving the aesthetic appearance and user experience associated with the docks and landing pads.

In further example embodiments, the docking or landing methods described herein may comprise an example control strategy having at least two main or primary objectives during docking or landing evolutions. For example, during docking or landing evolutions, the control strategy may seek to maintain aerial vehicles within boundaries of safety envelopes associated with the docks, and the control strategy may also seek to maintain visibility of at least portions of the landing pads associated with the docks.

In various examples, the safety envelopes may have various sizes and shapes that extend vertically upward from upper docking or landing surfaces of the docks. While aerial vehicles remain within the boundaries of the safety envelopes during docking evolutions, the control strategy may continue to instruct the aerial vehicles to descend toward the docks. If the aerial vehicles approach or contact the boundaries of the safety envelopes, the control strategy may instruct the aerial vehicles to pause or stop descent. Further, if the aerial vehicles move at least partially outside the boundaries of the safety envelopes, the control strategy may instruct the aerial vehicles to pause descent and/or ascend away from the docks.

Furthermore, as part of the control strategy, the landing pads may have various markers, indicia, or other indicators that are configured to be detected during different stages or phases of docking evolutions by aerial vehicles, while the aerial vehicles seek to remain within boundaries of safety envelopes. For example, a plurality of retroreflective markers may be configured to be detected during initial descent phases of docking evolutions at greater heights relative to docks. Then, one or more first pluralities of indicia may be configured to be detected during subsequent descent phases of docking evolutions at medium heights relative to docks. Moreover, one or more second or additional pluralities of indicia may be configured to be detected during later descent phases of docking evolutions at smaller heights relative to docks, as well as during a completion phase of docking evolutions when the aerial vehicles have docked or landed on the docks.

As described herein, the example control strategy having primary objectives may facilitate faster and more efficient docking evolutions, particularly when aerial vehicles are able to remain within boundaries of safety envelopes associated with the docks, and also maintain visibility of at least portions of the landing pads associated with the docks. If one or more objectives are not maintained during docking evolutions, the control strategy may instruct slower descent, stopping, and/or at least partial ascent, in order to allow the aerial vehicles to retry the docking evolutions while maintaining the primary objectives. Furthermore, the control strategy having primary objectives as described herein may simplify the higher level control of aerial vehicles during docking evolutions to primarily instructing vertical positioning, altitude, or velocity, while allowing the lower level controllers of aerial vehicles to maintain control of horizontal positioning or velocity during docking evolutions, e.g., in order to remain within boundaries of safety envelopes and over landing pads of docks.

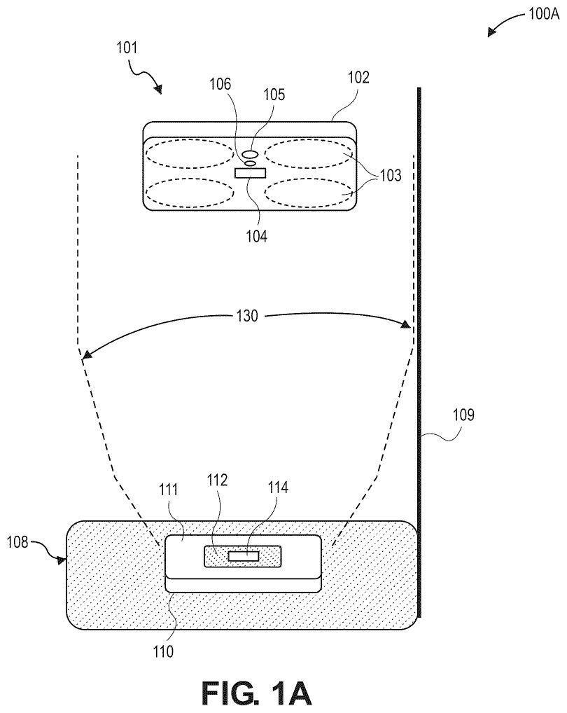

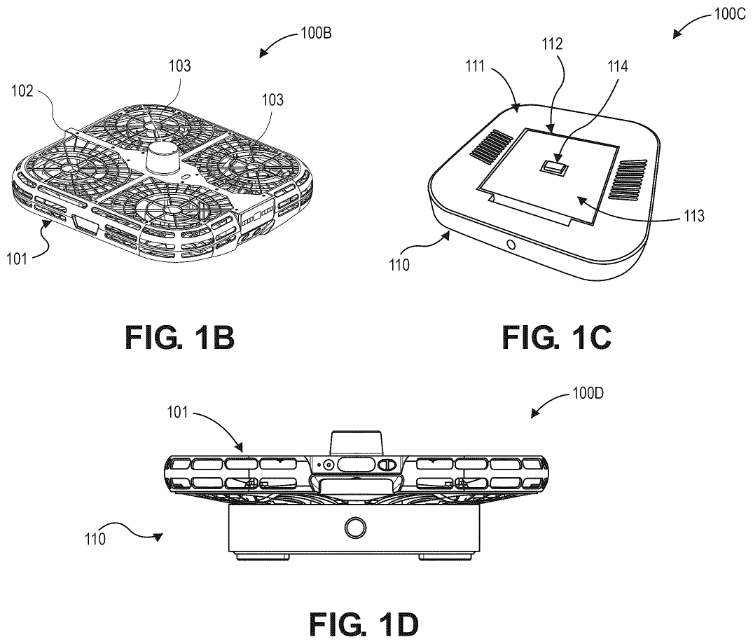

FIG. 1A is a schematic diagram 100A of an example docking system and associated method for aerial vehicles, in accordance with implementations of the present disclosure.

As shown in FIG. 1A, an example docking system and method may comprise a docking station or dock 110 configured to receive an aerial vehicle 101. The dock 110 may comprise a landing pad 112 on an upper surface 111, and the dock 110 may also comprise a safety envelope 130 that extends vertically upward from the upper surface 111.

The aerial vehicle 101 may comprise various types, sizes, shapes, or configurations of aerial vehicles. In some examples, the aerial vehicle 101 may comprise a quadcopter having a body or frame 102 and four motors and propellers 103 to provide thrust for flight and navigation. Other example aerial vehicles may comprise hexacopters, octocopters, or other types or configurations. In addition, the aerial vehicle 101 may comprise various processors, memories, power sources, controllers, transceivers, sensors, actuators, or other components to facilitate control and operation of the aerial vehicle to perform various tasks or functions.

In example embodiments described herein with respect to docking evolutions, the aerial vehicle 101 may comprise an electrical connector 104, a sensor 105, and a light source 106. The electrical connector 104 may comprise various pins or contacts configured to connect with a corresponding connector 114 of the dock 110, in order to transfer data, power, or other aspects between the aerial vehicle 101 and the dock 110. Various types of electrical connectors 104 may be used, such as physically engaging or contacting, inductive, magnetic, and/or other types of connections. Further, the electrical connector 104 may be approximately centered with respect to the frame 102 of the aerial vehicle 101, as illustrated, or the electrical connector 104 may have other positions and orientations with respect to the frame 102 of the aerial vehicle 101, as long as the corresponding connector 114 of the dock 110 is similarly positioned or oriented to align and connect with the electrical connector 104 upon docking.

The sensor 105 may comprise a camera, optical sensor, or other type of imaging sensor or device that is configured to detect at least portions of the dock 110 and landing pad 112. For example, the camera or imaging device 105 may detect various wavelengths of light that are reflected from various retroreflectors, markers, indicia, or other indicators presented by the landing pad 112. In addition, the camera or imaging device 105 may have various image capture characteristics or attributes, such as a field of view, resolution, exposure time, or other attributes, and various of the attributes may be adjustable or configurable. Further, the camera or imaging device 105 may have a particular position or orientation with respect to the frame 102 of the aerial vehicle 101, and as further described herein, portions of the landing pad 112 may also be formed or arranged to align or correspond to the position or orientation of the camera or imaging device 105.

The light source 106 may comprise a lighting element, light emitting diode (LED), or other illuminating component that is configured to emit light toward the dock 110 and landing pad 112. The emitted light may comprise infrared light, visible light, other wavelengths of light, or combinations thereof. The sensor 105 and light source 106 may be selected to cooperate with each other, in order to illuminate portions of the landing pad 112 by the light source 106 and enable detection by the sensor 105. In addition, the light source 106 may be positioned relatively close to or proximate the sensor 105, in order to ensure sufficient illumination of the dock 110 and landing pad 112 during the various stages or phases of docking evolutions, e.g., at greater heights or distances, upon completion of docking, and at various heights or distances therebetween.

The docking station or dock 110 may comprise a base, platform, plate, or other physical structure on which the aerial vehicle 101 may dock or land, e.g., after performing or completing one or more tasks or functions. In addition, the dock 110 may be positioned on a surface 108, such as a table, desk, shelf, counter, or other types of generally flat, horizontal surfaces. In some cases, the dock 110 may also be positioned proximate a wall 109 or other object or obstacle, which may affect the safety envelope 130 associated with the dock 110, as further described herein.

The dock 110 may comprise various types, sizes, shapes, or configurations of docks. In some examples, the dock 110 may comprise a substantially rectangular or square prismatic body or frame having an upper surface 111 configured to receive the aerial vehicle 101. Other example docks may comprise circular, elliptical, triangular, hexagonal, octagonal, or other regular or irregular shapes or configurations. In addition, the dock 110 may comprise various processors, memories, power sources or connections, controllers, transceivers, sensors, actuators, or other components to facilitate receipt of and communication with the aerial vehicle upon completing a docking evolution.

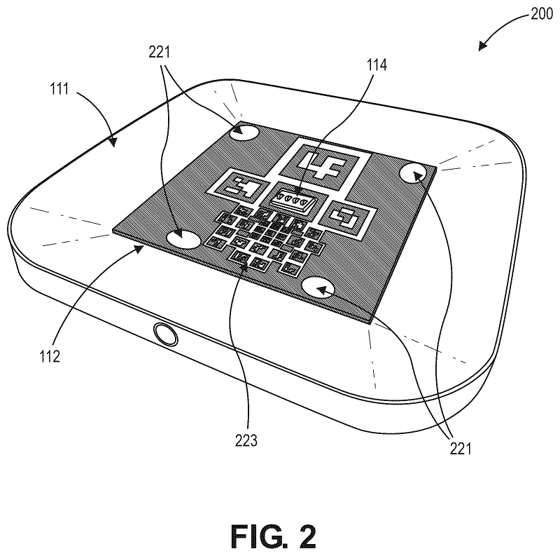

On the upper surface 111, the dock 110 may comprise a landing pad 112 and connector 114. The landing pad 112 may comprise various reflectors, markers, indicia, or other indicators that are configured to facilitate docking of the aerial vehicle 101 with the dock 110. The various portions of the landing pad 112 may be detected by the sensor 105, with illumination by the light source 106, of the aerial vehicle 101 during various stages or phases of a docking evolution. Further details of an example landing pad 112 are described herein at least with respect to FIGS. 2-4.

The connector 114 may be positioned on the upper surface 111 of the dock 110, and may be configured to mate, contact, engage, or otherwise connect with the electrical connector 104 of the aerial vehicle 101 upon completion of a docking evolution by the aerial vehicle 101. The connector 114 may operatively couple various components of the aerial vehicle 101 with various processors, memories, power sources or connections, controllers, transceivers, sensors, actuators, or other components of the dock 110, e.g., to facilitate transfer or communication of data, power, or other aspects therebetween.

Moreover, the dock 110 may further comprise a safety envelope 130 that extends vertically upward from the upper surface 111 of the dock 110. The safety envelope 130 may comprise a three-dimensional volume or space extending above the dock 110 and landing pad 112 within which the aerial vehicle 101 may be instructed to operate during a docking evolution. The safety envelope 130 may comprise boundaries that define a size, shape, or other geometrical aspects of the safety envelope 130. In some examples, the safety envelope 130 may comprise a substantially rectangular prismatic shape, cylindrical shape, conical shape, other regular or irregular shapes, and/or combinations thereof. In the example shown in FIG. 1A, the boundaries of the safety envelope 130 may comprise piecewise linear portions or segments that define, bound, or limit the three-dimensional volume of the safety envelope 130.

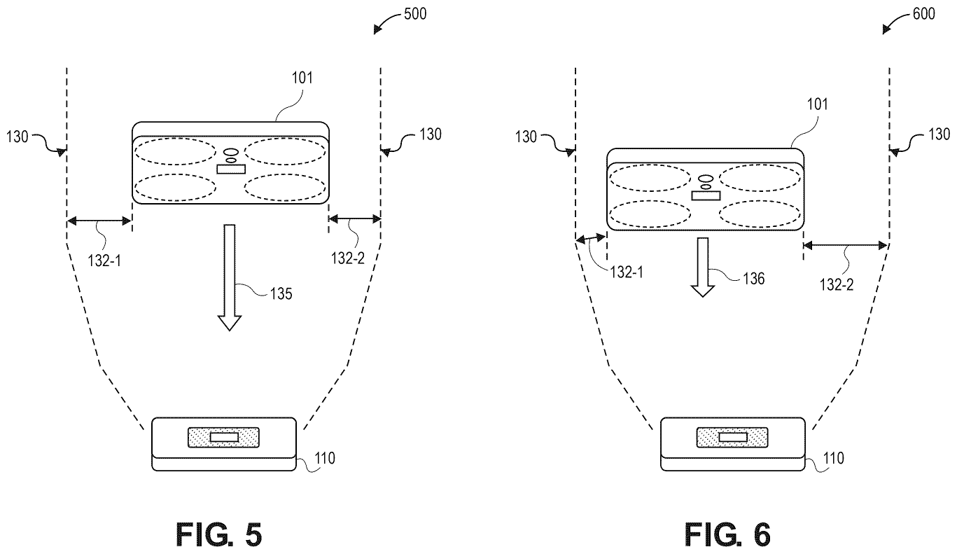

Further details of an example control strategy that seeks to maintain the aerial vehicle 101 within the safety envelope 130, while also maintaining the landing pad 112 within a field of view of the sensor 105 of the aerial vehicle 101, are described herein at least with respect to FIGS. 5-9.

FIG. 1B is a schematic diagram 100B of an example aerial vehicle, in accordance with implementations of the present disclosure, FIG. 1C is a schematic diagram 100C of an example dock for an aerial vehicle, in accordance with implementations of the present disclosure, and FIG. 1D is a schematic diagram 100D of an example aerial vehicle that is docked with the example dock, in accordance with implementations of the present disclosure.

In the example shown in FIG. 1B, the example aerial vehicle 101 may comprise a quadcopter having a body or frame 102 and four motors and propellers 103 to provide thrust for flight and navigation. In addition, the aerial vehicle 101 may comprise, on an underside thereof opposite the upper side illustrated in FIG. 1B, an electrical connector 104, a sensor 105, and a light source 106 as described herein at least with respect to FIG. 1A. Further, the aerial vehicle 101 may comprise various processors, memories, power sources, controllers, transceivers, sensors, actuators, or other components to facilitate control and operation of the aerial vehicle to perform various tasks or functions. Other example aerial vehicles may comprise hexacopters, octocopters, or other types or configurations.

Furthermore, the example aerial vehicle may comprise various sizes, dimensions, or shapes. For example, the aerial vehicle may comprise a length and width of approximately 220 mm×220 m, approximately 250 mm×250 mm, or other length and width dimensions. In addition, the aerial vehicle may comprise a height of approximately 50 mm, approximately 60 mm, or other height dimensions. Moreover, the electrical connector 104 may comprise a length and width of approximately 10 mm×10 mm, approximately 12 mm×17 mm, approximately 15 mm×15 mm, approximately 20 mm×20 mm, or other length and width dimensions.

In the example shown in FIG. 1C, the example dock 110 may comprise a base, platform, plate, or other physical structure on which an aerial vehicle 101 may dock or land, e.g., after performing or completing one or more tasks or functions. The dock 110 may comprise various types, sizes, shapes, or configurations of docks. In some examples, the dock 110 may comprise a substantially rectangular or square prismatic body or frame having an upper surface 111 configured to receive the aerial vehicle 101. Other example docks may comprise circular, elliptical, triangular, hexagonal, octagonal, or other regular or irregular shapes or configurations. In addition, the dock 110 may comprise various processors, memories, power sources or connections, controllers, transceivers, sensors, actuators, or other components to facilitate receipt of and communication with the aerial vehicle upon completing a docking evolution.

Further, the dock 110 may comprise a landing pad 112 within a portion of the upper surface 111, e.g., approximately centered within the upper surface 111. Additional details of an example landing pad 112 are described herein at least with respect to FIGS. 2-4. The dock 110 may also comprise a cover or shield 113 that is substantially the same size or dimensions as the landing pad 112 and protects or conceals the landing pad 112. In addition, the dock 110 may comprise a connector 114 that is configured to mate, contact, engage, or otherwise connect with an electrical connector 104 of the aerial vehicle 101.

The cover or shield 113 may comprise various materials, such as plastics, polymers, acrylics, composites, or other materials, that protect against damage or modification to the markers, indicia, or indicators of the landing pad 112. In addition, the cover or shield 113 may comprise sheets, films, or materials that enable transmission of one or more wavelengths of light, e.g., infrared bandpass protective covers, or other types of materials. In one example, the cover or shield 113 may comprise a polymethyl methacrylate (PMMA) infrared (IR) bandpass protective cover or other similar sheets, films, or materials. Further, the cover or shield 113 may be placed over, adhered to, or otherwise affixed to the landing pad 112 and/or the upper surface 111 of the dock 110.

Various example covers or shields 113 may enable detection of markers, indicia, or other indicators presented by the landing pads 112 responsive to illumination by appropriate wavelengths of light, while also reducing visibility of the landing pads 112 by users or customers utilizing the aerial vehicles 101 and docks 110. In this manner, the covers or shields 113 may maintain the desired function or operation of the docks 110 and landing pads 112, while also improving the aesthetic appearance and user experience associated with the docks 110 and landing pads 112.

The connector 114 may be approximately centered within the upper surface 111, landing pad 112, and shield 113, and the landing pad 112 and shield 113 may comprise openings or orifices through which the connector 114 extends to couple with an electrical connector 104 of the aerial vehicle 101. In addition, the connector 114 may be configured to mate, contact, engage, or otherwise connect with the electrical connector 104 of the aerial vehicle 101 upon completion of a docking evolution.

Furthermore, the example dock 110 may comprise various sizes, dimensions, or shapes. For example, the dock 110 may comprise a length and width of approximately 180 mm×180 m, approximately 190 mm×190 mm, approximately 200 mm×200 mm, or other length and width dimensions. In addition, the dock 110 may comprise a height of approximately 50 mm, approximately 60 mm, or other height dimensions. Further, the landing pad 112 and cover 113 may comprise a length and width of approximately 100 mm×100 m, approximately 110 mm×110 mm, approximately 120 mm×120 mm, or other length and width dimensions. Moreover, the connector 114 may comprise a length and width of approximately 10 mm×10 mm, approximately 12 mm×17 mm, approximately 15 mm×15 mm, approximately 20 mm×20 mm, or other length and width dimensions.

As shown in FIG. 1D, the aerial vehicle 101 may have docked or landed on the dock 110. In some examples, the upper surface 111 of the dock 110 may comprise physical structures, such as ramps, slopes, or other guiding surfaces, that facilitate reliable and consistent docking of the aerial vehicle 101 on the dock 110. Such guiding surfaces may also assist with proper connection between the electrical connector 104 of the aerial vehicle 101 and the connector 114 of the dock 110.

For example, the surfaces on the upper surface 111 of the dock 110 that are positioned around the periphery of the landing pad 112 and cover 113 may comprise ramps or slopes that are angled radially inward and downward toward a center of the dock 110. By interaction between surfaces, landing feet or pads, or other structures on an underside of the aerial vehicle 101 and the guiding surfaces of the upper surface 111 of the dock 110, the aerial vehicle 101 may reliably and consistently land in a desired position, e.g., substantially centered, on the dock 110 under force of gravity.

FIG. 2 is a schematic diagram 200 of an example dock having a landing pad for an aerial vehicle, in accordance with implementations of the present disclosure.

As shown in FIG. 2, an example dock 110 may comprise an upper surface 111, a landing pad 112, and a connector 114. For clarity of the illustration of the landing pad 112, a cover or shield is not illustrated in FIG. 2. The landing pad 112 may be positioned within a portion of the upper surface 111, e.g., substantially centered within the upper surface 111 of the dock 110. In addition, the landing pad 112 may comprise various shapes, such as square, rectangular, circular, elliptical, triangular, hexagonal, octagonal, or other regular or irregular shapes.

Further, the landing pad 112 may comprise one or more pluralities of reflectors, markers, indicia, or other indicators that are configured to be detected by a sensor of an aerial vehicle during docking evolutions. For example, the landing pad 112 may comprise a first plurality of retroreflectors 221, and one or more additional pluralities of markers or indicia 223.

The plurality of retroreflectors 221 may comprise various materials that are placed, attached, or adhered to portions of the landing pad 112. The retroreflectors 221 may be configured to reflect one or more wavelengths of light, e.g., infrared light, various wavelengths of visible light, or other wavelengths. In one example, the plurality of retroreflectors 221 may comprise Nikkalite® 8100 Series retroreflective tapes or films that are configured to reflect one or more wavelengths of light. Generally, the plurality of retroreflectors 221 may be detected by a sensor of an aerial vehicle at greater heights or distances from the landing pad 112 of the dock.

The pluralities of markers or indicia 223 may comprise various symbols, characters, codes, or other indicia that may be printed, placed, or adhered on portions of the landing pad 112. In one example, the markers or indicia 223 may comprise AprilTags®, quick response (QR) codes, or other similar indicia or codes. Further, multiple sets of the markers or indicia 223 may have different sizes and/or shapes. For example, sets of relatively larger-sized markers or indicia 223 may be detected by a sensor of an aerial vehicle at relatively greater heights or distances from the landing pad 112 of the dock, additional sets of medium-sized markers or indicia 223 may be detected by a sensor of an aerial vehicle at medium heights or distances from the landing pad 112 of the dock, and further sets of smaller-sized markers or indicia 223 may be detected by a sensor of an aerial vehicle at relatively smaller heights or distances from the landing pad 112 of the dock.

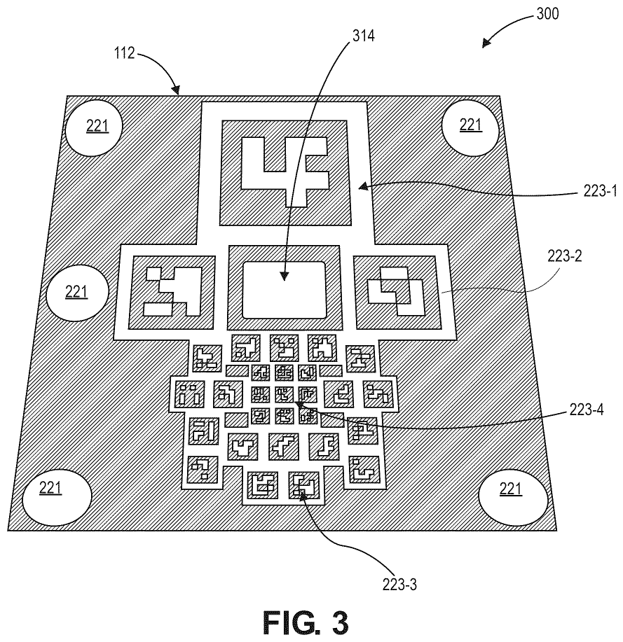

FIG. 3 is a schematic diagram 300 of an example landing pad for a dock of an aerial vehicle, in accordance with implementations of the present disclosure.

As shown in FIG. 3, the example landing pad 112 may be similar to the landing pad described herein with respect to FIG. 2. The landing pad 112 may comprise one or more pluralities of reflectors, markers, indicia, or other indicators that are configured to be detected by a sensor of an aerial vehicle during docking evolutions. For example, the landing pad 112 may comprise a plurality of retroreflectors 221 and one or more additional pluralities of markers or indicia 223-1, 223-2, 223-3, 223-4, as well as an orifice or opening 314 to receive a connector 114 of the dock. Various features of the landing pad 112, retroreflectors 221, and/or markers or indicia 223 described herein with respect to FIG. 2 may also apply to similar elements described with respect to FIG. 3.

The plurality of retroreflectors 221 may comprise various reflective tapes, films, or other materials that may be placed, attached, or adhered to the landing pad 112. As illustrated in FIGS. 2 and 3, the plurality of retroreflectors 221 may comprise four, five, or other numbers of retroreflectors. In addition, the plurality of retroreflectors 221 may be positioned at various locations or positions within the landing pad 112. Generally, the plurality of retroreflectors 221 may be positioned at corners or outer edges of the landing pad 112, in order to maximize a distance or spacing between respective retroreflectors, which may facilitate detection of the plurality of retroreflectors 221 by a sensor of an aerial vehicle at relatively greater heights or distances from the landing pad 112. Further, the retroreflectors 221 may be arranged or configured in a rotationally asymmetric pattern or formation in order to facilitate detection of the retroreflectors and subsequent determination of position and/or orientation relative to the detected retroreflectors.

In some examples, the plurality of retroreflectors 221 may comprise substantially circular shapes having sizes that are approximately 10 mm in diameter, approximately 15 mm in diameter, or other sizes. In other examples, the plurality of retroreflectors 221 may comprise other regular or irregular shapes and respective sizes. By increasing or maximizing a distance or spacing between respective retroreflectors, reliable detection of each of the plurality of retroreflectors 221 by a sensor of an aerial vehicle at relatively greater heights or distances may be improved. For example, the retroreflectors 221 may be detected by a sensor of an aerial vehicle at heights or distances of approximately 70 cm, approximately 100 cm, approximately 150 cm, or other heights from the landing pad 112.

In addition, various image capture characteristics of a sensor, e.g., imaging device, of the aerial vehicle may be adjusted, configured, or modified in order to reliably detect the plurality of retroreflectors 221. For example, an exposure time of the imaging device may be set or configured to a relatively low or short time value, such that the retroreflectors may be perceived as relatively brighter within imaging data whereas other objects or elements within the field of view of the imaging device may be perceived as relatively darker within imaging data. In addition, the field of view of the imaging device may also be set or configured to capture a relatively wider field of view, thereby facilitating detection of the retroreflectors within a relatively larger area or space below the aerial vehicle. Further, the resolution of the imaging device may be set or configured to detect retroreflectors from a desired height or distance from the landing pad, thereby facilitating detection of the retroreflectors from an initial or relatively greater height or distance below the aerial vehicle. Various other image capture characteristics of the sensor of the aerial vehicle may be selected or configured to facilitate reliable detection of the retroreflectors.

Furthermore, various light emission characteristics of a light source of the aerial vehicle may also be adjusted, configured, or modified in order to reliably illuminate and detect the plurality of retroreflectors 221. For example, one or more wavelengths of light to be emitted by the light source may be selected that correspond to wavelengths of light that can be reliably detected by the sensor of the aerial vehicle. In addition, a power or brightness of the light to be emitted by the light source may be selected to facilitate detection of the retroreflectors within a relatively larger area or space and/or at a greater height or distance below the aerial vehicle. Various other light emission characteristics of the light source of the aerial vehicle may be selected or configured to facilitate reliable illumination and detection of the retroreflectors.

The pluralities of markers or indicia 223 may comprise various symbols, characters, or codes that may be printed, placed, or adhered to the landing pad 112. As shown in FIGS. 2 and 3, the pluralities of markers 223 may comprise AprilTags®, QR codes, or other similar codes or symbols. The pluralities of markers 223 may be printed on paper or other substrates, e.g., with a resolution of approximately 600 dpi (dots per inch) or other resolutions. In addition, each of the markers may be rotationally asymmetric in order to facilitate detection of the markers and subsequent determination of position and/or orientation relative to the detected markers.

In examples described herein, the pluralities of markers 223 may comprise multiple sets of markers 223-1, 223-2, 223-3, 223-4. Although four sets of markers are shown and described herein with respect to FIG. 3, other example landing pads may comprise other numbers of sets of markers. Generally, each set of markers 223-1, 223-2, 223-3, 223-4 may comprise a different size and/or shape, such that different sets of markers may be reliably detected by a sensor of an aerial vehicle at different respective heights or distances from the landing pad 112.

For example, a first set of markers 223-1 may have a relatively larger size, and may be detected by a sensor of an aerial vehicle at relatively greater heights from the landing pad. The first set of markers 223-1 may have dimensions of approximately 40 mm×40 mm, approximately 50 mm×50 mm, or other similar dimensions, and may be detected at heights or distances of approximately 70 cm, approximately 100 cm, approximately 150 cm, or others. In addition, a second set of markers 223-2 may have a relatively medium size, and may be detected by a sensor of an aerial vehicle at relatively medium heights from the landing pad. The second set of markers 223-2 may have dimensions of approximately 20 mm×20 mm, approximately 30 mm×30 mm, or other similar dimensions, and may be detected at heights or distances of approximately 50 cm, approximately 75 cm, approximately 115 cm, or others. Further, a third set of markers 223-3 may have a relatively smaller size, and may be detected by a sensor of an aerial vehicle at relatively smaller heights from the landing pad. The third set of markers 223-3 may have dimensions of approximately 8 mm×8 mm, approximately 10 mm×10 mm, or other similar dimensions, and may be detected at heights or distances of approximately 30 cm, approximately 50 cm, approximately 70 cm, or others. Finally, a fourth set of markers 223-4 may have a relatively smallest size, and may be detected by a sensor of an aerial vehicle at relatively smallest heights from the landing pad, e.g., close to or upon completing a docking evolution. The fourth set of markers 223-4 may have dimensions of approximately 3 mm×3 mm, approximately 5 mm×5 mm, or other similar dimensions, and may be detected at heights or distances of approximately 0 cm to 10 cm, approximately 25 cm, approximately 35 cm, or others.

Generally, sets of markers having relatively larger size, e.g., first and second sets of markers 223-1, 223-2, may be placed at various positions around the landing pad 112, such as near outer edges or peripheries of the landing pad, since such markers may be detected from relatively greater heights when substantially all of the landing pad may be within a field of view of a sensor of an aerial vehicle. Moreover, sets of markers having relatively smaller size, e.g., third and fourth sets of markers 223-3, 223-4, may be placed at positions that more closely correspond to a position of the sensor relative to the body or frame of the aerial vehicle, since such markers may be detected from relatively smaller heights, or upon completion of a docking evolution, when only portions of the landing pad proximate the position of the sensor may be within a field of view of the sensor of the aerial vehicle.

In addition, various image capture characteristics of a sensor, e.g., imaging device, of the aerial vehicle may be adjusted, configured, or modified in order to reliably detect the pluralities of markers 223. For example, the field of view of the imaging device may be set or configured to capture an appropriate field of view, thereby facilitating detection of all or portions of the landing pad and the markers placed therein at different respective heights or distances below the aerial vehicle. Further, the resolution of the imaging device may be set or configured to detect markers of different sizes or shapes from different respective heights or distances from the landing pad, thereby facilitating detection of respective sets of markers from different respective heights or distances below the aerial vehicle. Various other image capture characteristics of the sensor of the aerial vehicle may be selected or configured to facilitate reliable detection of the markers.

Furthermore, various light emission characteristics of a light source of the aerial vehicle may also be adjusted, configured, or modified in order to reliably illuminate and detect the plurality of markers 223. For example, one or more wavelengths of light to be emitted by the light source may be selected that correspond to wavelengths of light that can be reliably detected by the sensor of the aerial vehicle. In addition, a power or brightness of the light to be emitted by the light source may be selected to facilitate detection of all or portions of the landing pad and markers placed therein at different respective heights or distances below the aerial vehicle. Various other light emission characteristics of the light source of the aerial vehicle may be selected or configured to facilitate reliable illumination and detection of the markers.

During an initial phase of a docking evolution of an aerial vehicle, the sensor of the aerial vehicle may initially detect at least a portion a landing pad 112 at an initial height or distance, e.g., a greatest height or distance. Upon completing a final phase of the docking evolution, the sensor of the aerial vehicle may detect at least a portion of the landing pad 112 at a docked height or distance, e.g., a smallest height or distance.

At the initial phase of the docking evolution, the sensor and light source of the aerial vehicle may be actuated. In addition, the plurality of retroreflectors 221 may be illuminated by the light source and detected by the sensor during the initial phase at the greatest height or distance. Then, the aerial vehicle may begin reducing its altitude in order ultimately dock or land on the dock.

During subsequent phases of the docking evolution, the sensor and light source of the aerial vehicle may continue to be actuated. As the height or distance between the aerial vehicle and the dock decreases, an angle of reflection between the sensor and light source of the aerial vehicle may correspondingly increase, such that fewer light rays reflected by the retroreflectors may be detected by the sensor. As a result, with decreasing height or distance between the aerial vehicle and the dock, the retroreflectors may become less brightly illuminated, and other portions of the landing pad, e.g., the pluralities of markers or indicia, may be relatively more illuminated. In addition, with decreasing height or distance between the aerial vehicle and the dock, the retroreflectors may gradually move outside the field of view of the sensor, whereas all or some of the pluralities of markers or indicia of the landing pad may remain within the field of view of the sensor.

Furthermore, as the aerial vehicle progresses through subsequent phases of the docking evolution at gradually lesser heights or distances from the dock, the field of view and resolution of the sensor of the aerial vehicle may reliably detect different sets of markers having different respective sizes or shapes over time. For example, the first set of markers 223-1 may be detected at a first height from the dock, the second set of markers 223-2 may be detected at a second height from the dock, the third set of markers 223-3 may be detected at a third height from the dock, and the fourth set of markers 223-4 may be detected at a fourth height from the dock. In such examples, the first height may be a lesser height than the initial height at which the retroreflectors may be detected, and the first height may be greater than the second, third, and fourth heights. In addition, the second height may be less than the first height, the third height may be less than the second height, and the fourth height may be less than the third height. Further, the fourth height may be associated with substantial completion of the docking evolution, e.g., the aerial vehicle has landed on the dock.

Each of the sets of markers 223 having a relatively smaller size may be positioned, as a group or set, relatively closer to a position of the sensor of the aerial vehicle as compared to sets of markers having a relatively larger size. As illustrated in FIG. 3, the fourth set of markers 223-4 is positioned substantially centered and closely clustered around a position of the sensor of the aerial vehicle, and the third set of markers 223-3 is also positioned substantially centered around the position of the sensor but around a periphery of the fourth set of markers 223-4 and at a greater radial distance from the position of the sensor. Likewise, the second set of markers 223-2 is positioned adjacent a periphery of a portion of the third set of markers 223-3 and at a greater radial distance from the position of the sensor, and the first set of markers 223-1 is positioned adjacent a periphery of a portion of the second set of markers 223-2 and at a greatest radial distance from the position of the sensor.

In some alternative example embodiments, a landing pad 112 of a dock 110 may not include any retroreflectors 221 and may instead only include respective sets of markers 223. For example, in such scenarios, the dock 110 may be assumed to be placed or positioned within an environment with sufficient ambient light, and/or the aerial vehicle may be assumed to perform docking evolutions generally only at specified times during which sufficient ambient light is present within the environment. In such examples, the aerial vehicle may also not include or actuate an onboard light source, and the imaging sensor may be actuated with various image capture characteristics that enable reliable detection of respective sets of markers 223 using ambient light within the environment.

Using the combination of retroreflectors 221 and respective sets of markers 223 placed, attached, or adhered on a landing pad 112 of a dock 110, an aerial vehicle may reliably execute and complete a docking evolution using an onboard sensor and light source. The combination of retroreflectors 221 and respective sets of markers 223 of the landing pad 112 may enable reliable detection of different portions of the landing pad 112 during different phases or stages of a docking evolution associated with different heights or distances from the landing pad 112. As a result, docking evolutions of aerial vehicles may be efficiently and reliably performed, while minimizing cost and complexity associated with docking systems and associated methods.

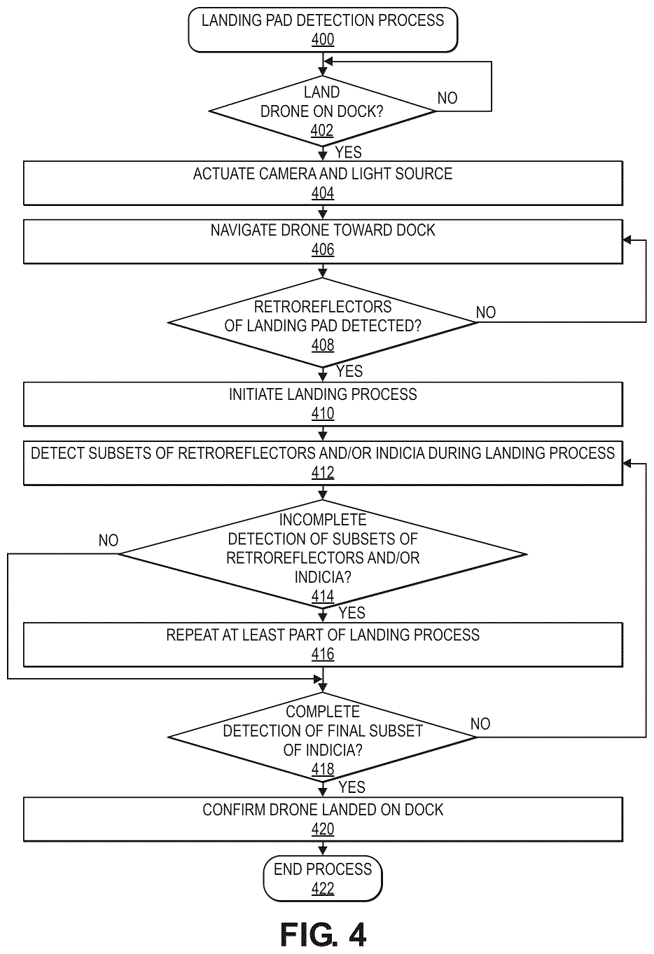

FIG. 4 is a flow diagram illustrating an example landing pad detection process 400, in accordance with implementations of the present disclosure.

The process 400 may begin by determining whether to land a drone on a dock, as at 402. For example, an aerial vehicle may determine whether to dock or land at a docking station. The aerial vehicle may have completed one or more tasks or functions, may need to recharge onboard power supplies, may need to receive and transfer data or other information, and/or may comprise other criteria related to determining whether to dock or land at the docking station. Further, a control system of the aerial vehicle may determine whether to dock or land at the docking station.

If the aerial vehicle has not determined to dock or land at the docking station, step 402 may repeat or iterate until such a determination to dock or land is made. For example, the aerial vehicle may continue performance of various tasks or functions.

If, however, the aerial vehicle has determined to dock or land at the docking station, the process 400 may continue by actuating a camera and light source, as at 404. For example, a sensor, such as a camera or imaging device, and a light source onboard the aerial vehicle may be actuated in order to facilitate docking of the aerial vehicle at the dock. Further, a control system of the aerial vehicle may instruct actuation of the camera and light source.

The process 400 may then proceed by navigating the drone toward the dock, as at 406. For example, the aerial vehicle may navigate or maneuver towards a position of the docking station. The aerial vehicle may utilize various sensors, indoor positioning sensors or systems, or other positioning or localization devices or systems to navigate towards the dock, e.g., within an indoor space. In addition, the aerial vehicle may utilize one or more stored maps or mapping algorithms and techniques to navigate toward the dock. Further, a control system may instruct navigation of the aerial vehicle toward the dock.

The process 400 may continue to determine whether retroreflectors of a landing pad have been detected, as at 408. For example, data, e.g., imaging data, captured by the sensor of the aerial vehicle may be processed to determine whether one or more retroreflectors of a landing pad of the dock have been detected. Various image processing techniques or algorithms may be used to process and analyze the imaging data. As described herein, the retroreflectors may be illuminated by the light source and detected by the camera during an initial phase of a docking evolution, e.g., associated with a greatest height or distance from the docking station. As part of the detection of the retroreflectors, the imaging data may also be processed to determine a pose of the aerial vehicle relative to the landing pad and/or dock, e.g., based on detected positions or centers of multiple retroreflectors within the imaging data. Further, a control system of the aerial vehicle may determine whether one or more retroreflectors of a landing pad of the dock have been detected.

If retroreflectors of the landing pad have not been detected, the process 400 may return to step 406 and continue to navigate the drone toward the dock. If, however, one or more retroreflectors of the landing pad of the dock have been detected, the process 400 may proceed to initiate a landing process, as at 410. For example, the docking or landing process may comprise one or more control strategies to guide and maneuver the aerial vehicle to a docking or landing configuration on the docking station. Various control strategies may be used to instruct the motors, propellers, and other components of the aerial vehicle to enable docking at the docking station. Further, a control system of the aerial vehicle may initiate a docking or landing process.

The process 400 may then continue with detecting subsets of retroreflectors and/or indicia during the landing process, as at 412. For example, during the landing process, the aerial vehicle may reduce an altitude, height, or distance from the docking station. During such maneuvers, different sets of retroreflectors and/or indicia may be detected within imaging data, e.g., based on image capture characteristics of the camera, light emission characteristics of the light source, and various phases or stages of the landing process. Various image processing techniques or algorithms may be used to process and analyze the imaging data. As described herein, retroreflectors may be detected during an initial phase of the landing process, and different sets of indicia or markers may be detected during subsequent phases of the landing process as the aerial vehicle reduces altitude and approaches the docking or landing configuration at the dock. As part of the detection of the retroreflectors and/or markers, the imaging data may also be processed to determine a pose of the aerial vehicle relative to the landing pad and/or dock, e.g., based on detected positions or centers of multiple retroreflectors within the imaging data, and/or based on detected portions, corners, or edges of one or more markers within the imaging data. Further, a control system of the aerial vehicle may detect subsets of the retroreflectors and/or indicia during the landing process.

The process 400 may proceed with determining whether there is incomplete detection of subsets of retroreflectors and/or indicia, as at 414. For example, if incomplete sets of retroreflectors, markers, or indicia are detected, this may indicate incorrect or inaccurate positioning of the aerial vehicle relative to the docking station during a portion of the landing process. For example, a horizontal position of the aerial vehicle may not be aligned with a center or desired horizontal position with respect to the landing pad and/or dock. Further, a control system of the aerial vehicle may determine whether incomplete sets of retroreflectors, markers, or indicia are detected.

If incomplete sets of retroreflectors, markers, or indicia are detected, the process 400 may continue by repeating at least part of the landing process, as at 416. For example, depending upon the control strategy, one or more adjustments or changes to the landing process may be executed or implemented. For example, the aerial vehicle may adjust a horizontal position relative to the dock, may adjust a vertical position relative to the dock, may retry one or more portions of the landing process, and/or may perform various other corrective actions. Further, a control system of the aerial vehicle may instruct repeating of at least part of the landing process.

After repeating at least part of the landing process at step 416, or if no incomplete sets of retroreflectors, markers, or indicia are detected at step 414, the process 400 may proceed by determining whether there is complete detection of a final subset of indicia, as at 418. For example, the final subset of indicia may be associated with substantial completion of a docking evolution of the aerial vehicle, e.g., the aerial vehicle is at a minimum height of approximately 1 cm, approximately 2 cm, approximately 3 cm, approximately 5 cm, or other heights above the dock, and/or the aerial vehicle is substantially in a docking or landing configuration at the dock. As described herein, the final subset of indicia may comprise a set of markers that is centered around the position of the camera and having a size and shape that is reliably detected by the camera in the docking or landing configuration. As part of the detection of the markers, the imaging data may also be processed to determine a pose of the aerial vehicle relative to the landing pad and/or dock, e.g., based on detected portions, corners, or edges of one or more markers within the imaging data. Further, a control system may determine whether the final subset of indicia is completely detected.

If the final subset of indicia is not completely detected, e.g., the landing process is not yet complete, the process 400 may return to step 412 to continue the landing process and corresponding detection of subsets of retroreflectors and/or indicia. If, however, the final subset of indicia is completely detected, the process 400 may continue to confirm that the drone has landed on the dock, as at 420. Various additional sensors may also be utilized to determine that the aerial vehicle has completed the docking evolution and is in the docking configuration at the docking station. Further, a control system may confirm that the aerial vehicle has successfully docked with the docking station.

The process 400 may then end, as at 422.

As described herein, an example control strategy for an aerial vehicle 101 during a docking or landing evolution may seek to maintain the aerial vehicle 101 within a safety envelope 130 associated with the dock 110, while also maintaining a landing pad of the dock 110 within a field of view of a sensor, e.g., an imaging device, of the aerial vehicle 101. Various features or aspects of the landing pad and other components of the dock 110, as well as the sensor, light source, and other components of the aerial vehicle 101, are described herein at least with respect to FIGS. 1A-4.

In example embodiments, a dock or docking station 110 may comprise a safety envelope 130 that extends vertically upward from the upper surface of the dock 110. The safety envelope 130 may comprise a selected or determined three-dimensional volume or space extending above the dock 110 and landing pad within which the aerial vehicle 101 may be instructed to operate during a docking evolution. The safety envelope 130 may comprise boundaries that define a size, shape, or other geometrical aspects of the safety envelope 130. Further, the boundaries may comprise mathematically, spatially, or geometrically selected or determined limits or bounds, and may not comprise any physical guides, rails, limits, or other structures. In some examples, the safety envelope 130 may comprise a substantially rectangular prismatic shape, cylindrical shape, conical shape, other regular or irregular shapes, and/or combinations thereof. In the examples shown in FIGS. 5-8, the boundaries of the safety envelope 130 may comprise piecewise linear portions or segments that define, bound, or limit the three-dimensional volume of the safety envelope 130. In other examples, the safety envelope 130 may also comprise complex and/or irregular shapes, e.g., having curved or asymmetric portions, particularly at greater heights from the dock 110 at which a field of view of the imaging sensor may encompass greater areas or dimensions in which the dock 110 may be positioned.

Generally, a safety envelope 130 may define one or more safety margins between portions of an aerial vehicle 101 and boundaries of the safety envelope 130. In some examples, the safety margins may comprise substantially horizontal distances, gaps, or margins, e.g., between one or more portions of the boundaries of the safety envelope 130 and one or more portions of an aerial vehicle 101 that are closest to the portions of the boundary. For example, if a safety envelope 130 is rotationally symmetric about a vertical axis that extends through a center of the dock 110, the safety margins may be substantially equal distances or gaps between portions of an aerial vehicle 101 and portions of the boundaries of the safety envelope 130 when the aerial vehicle 101 is substantially centered over the dock 110. In addition, if the aerial vehicle 101 moves or navigates closer to a first portion of the boundaries of the safety envelope 130, a safety margin to at least the first portion may become smaller, and correspondingly, a safety margin to at least a second portion opposite the first portion of the boundaries of the safety envelope 130 may become larger. As a result, various movements of an aerial vehicle 101 within a safety envelope 130 may cause corresponding changes to respective safety margins to various portions of the boundaries of the safety envelope 130.

In other examples, the safety margins may comprise shortest or smallest distances, gaps, or margins between one or more portions of the boundaries of the safety envelope 130 and one or more portions of an aerial vehicle 101 that are closest to the portions of the boundary. For example, the shortest or smallest distances, gaps, or margins may not necessarily correlate or correspond to horizontal distances or lie within horizontal planes, and instead, the shortest or smallest distances, gaps, or margins may be angled or rotated by various amounts or degrees relative to a vertical axis and/or one or more horizontal planes. In some cases, the shortest or smallest distances, gaps, or margins may comprise distances that are generally perpendicular to one or more portions of the boundaries of the safety envelope 130.

In addition, a safety envelope 130 may have different sizes or shapes within a horizontal plane at various different vertical heights or distances from the dock 110. For example, a portion of the safety envelope 130 that is at a greatest height from the dock 110 may have a largest horizontal size or shape and/or a largest area within a respective horizontal plane. In addition, a portion of the safety envelope 130 that is at a smallest height from the dock 110 may have a smallest horizontal size or shape and/or a smallest area within a respective horizontal plane. Various portions of the safety envelope 130 between the greatest and smallest heights may have horizontal sizes or shapes and/or areas within respective horizontal planes that are generally between the largest and smallest sizes, shapes, or areas, e.g., dependent upon an overall three-dimensional shape or volume of the safety envelope 130.

For a safety envelope 130 that has a largest size, shape, or area at a greatest height from the dock 110 and a smallest size, shape, or area at a smallest height from the dock 110, respective safety margins between portions of an aerial vehicle 101 and boundaries of the safety envelope 130 may also decrease as the aerial vehicle 101 descends relative to the safety envelope 130 and toward the dock 110 during a docking evolution. In some examples, the largest available safety margins when an aerial vehicle 101 is at a greatest height and centered within a safety envelope 130 may comprise approximately 8 cm, approximately 10 cm, or other values. In addition, the smallest available safety margins when an aerial vehicle 101 is at a smallest height and centered within a safety envelope 130 may comprise approximately 1 cm, approximately 1.5 cm, approximately 2 cm, or other values.

Further, a safety envelope 130 may be selected or configured with particular desired safety margins based on various factors. For example, the safety envelope 130 and corresponding safety margins may be selected or determined based on distance or proximity to obstacles, walls, furniture, furnishings, or other objects, field of view limits, resolution, or other image capture characteristics of a sensor of an aerial vehicle, uncertainty associated with a current pose of an aerial vehicle relative to the dock and associated safety envelope, mechanical or physical tolerances associated with a completed docking evolution between an aerial vehicle and a dock, and/or other factors. Generally, as an aerial vehicle 101 descends toward a dock 110, the safety margins of a safety envelope 130 may decrease in order to ensure that the aerial vehicle 101 can successfully and reliably complete a docking evolution with the dock 110.

In example embodiments, an example control strategy may comprise at least a first objective to maintain an aerial vehicle 101 within boundaries of a safety envelope 130 during a docking evolution, and at least a second objective to maintain a landing pad of a dock 110 within a field of view of an imaging sensor of the aerial vehicle 101. When the aerial vehicle 101 is within the boundaries of the safety envelope 130 and can detect the landing pad, the aerial vehicle 101 may continue to descend toward the dock 110. In addition, a speed of descent toward the dock 110 may be determined based at least in part on the safety margins between the aerial vehicle 101 and boundaries of the safety envelope 130, e.g., higher descent speeds with larger safety margins, and slower descent speeds with smaller safety margins. Further, when the aerial vehicle 101 approaches or contacts the boundaries of the safety envelope 130 and can detect all or a portion of the landing pad, the aerial vehicle 101 may pause or stop descent toward the dock 110, and while paused, the aerial vehicle 101 may attempt or continue to adjust its horizontal position towards a center of the safety envelope 130, thereby increasing safety margins between the aerial vehicle 101 and boundaries of the safety envelope 130 and also enabling detection of the landing pad within a field of view of the imaging sensor. Moreover, if the aerial vehicle 101 navigates outside the boundaries of the safety envelope 130 and can detect only a portion or no portion of the landing pad, the aerial vehicle 101 may pause or stop descent and/or ascend away from the dock 110 in order to prevent further navigation outside the boundaries, and also to facilitate adjustment of the horizontal position towards a center of the safety envelope 130 and detection of the landing pad within a field of view of the imaging sensor.

Generally, the example control strategy may prioritize descent speed during docking when an aerial vehicle 101 remains within boundaries of a safety envelope 130. During such descent, lower level controllers of an aerial vehicle 101 may continuously adjust a horizontal position of the aerial vehicle 101 to try to remain substantially centered over the dock 110 and within the safety envelope 130. Further, when an aerial vehicle 101 moves outside the boundaries of the safety envelope 130, the example control strategy may prioritize horizontal alignment with the dock 110 and safety envelope 130 by pausing or stopping descent and/or causing or instructing ascent of the aerial vehicle 101. During such pauses or ascent, lower level controllers of an aerial vehicle 101 may also continuously adjust a horizontal position of the aerial vehicle 101 to try to return to being substantially centered over the dock 110 and within the safety envelope 130.

FIG. 5 is a schematic diagram 500 of an example docking method for aerial vehicles during a first portion, in accordance with implementations of the present disclosure.

As shown in FIG. 5, an example aerial vehicle 101 may be executing a first portion of a docking evolution to land on dock 110. The dock 110 may have an associated safety envelope 130 that extends vertically above the upper surface of the dock 110.

In the example of FIG. 5, the aerial vehicle 101 may be substantially centered within the safety envelope 130 and over the dock 110, e.g., within a threshold distance or range of approximately 1 cm, approximately 2 cm, or other distances from a center over the dock, and an imaging sensor of the aerial vehicle 101 may detect all of a landing pad, e.g., having retroreflectors and/or indicia, present on an upper surface of the dock 110. When the aerial vehicle 101 is substantially centered within the safety envelope 130, respective safety margins 132 between boundaries of the safety envelope 130 and portions of the aerial vehicle 101 closest to respective boundaries may be substantially equal. As shown in FIG. 5, the safety margins 132-1, 132-2 shown on left and right sides of the aerial vehicle 101 may be substantially equal.

Although only safety margins 132-1, 132-2 associated with left and right sides of the aerial vehicle 101 are illustrated in FIG. 5, it is understood that the safety envelope 130 comprises a three-dimensional volume or shape within which the aerial vehicle 101 is operating, such that respective safety margins can be determined in multiple directions between portions of the aerial vehicle 101 and portions of the safety envelope 130 at an approximate altitude associated with a position of the aerial vehicle 101. For clarity of discussion, only a portion of the plurality of safety margins 132 associated with the three-dimensional safety envelope 130 are discussed herein.

Moreover, in order to determine a descent speed 135 of the aerial vehicle 101 during the first portion of the docking evolution, a smallest safety margin between any portion of the aerial vehicle 101 and any respective portion of the safety envelope 130 may be considered. In the example of FIG. 5, because all safety margins 132 are substantially equal, the smallest safety margin from among all safety margins 132 around the aerial vehicle 101 may comprise a value equal to that of each of the substantially equal safety margins between the aerial vehicle 101 and the safety envelope 130.

As a result, during the first portion of the docking evolution in which the aerial vehicle 101 is substantially centered within the safety envelope 130, the descent speed 135 may be selected or determined to be a highest or fastest descent speed based on the value of the smallest safety margin from among all safety margins 132 around the aerial vehicle 101. The highest or fastest descent speed 135 is schematically illustrated in FIG. 5 by a largest or longest arrow associated with descent speed 135. In this manner, descent speed of the aerial vehicle 101 toward the dock 110 may be prioritized when the aerial vehicle 101 is substantially centered within the safety envelope 130 and over the dock 110, as well as an imaging sensor of the aerial vehicle 101 being able to detect all of a landing pad, e.g., having retroreflectors and/or indicia, present on an upper surface of the dock 110. Further, concurrently with descent at the fastest descent speed 135 when the aerial vehicle 101 is substantially centered within the safety envelope 130, continuous horizontal adjustment of the position of the aerial vehicle 101 within the safety envelope 130, e.g., as continuously instructed by lower level controllers of the aerial vehicle 101 during docking evolutions, may seek to maintain the aerial vehicle 101 aligned with a center of the safety envelope 130.

FIG. 6 is a schematic diagram 600 of an example docking method for aerial vehicles during a second portion, in accordance with implementations of the present disclosure.

As shown in FIG. 6, an example aerial vehicle 101 may be executing a second portion of a docking evolution to land on dock 110. The dock 110 may have an associated safety envelope 130 that extends vertically above the upper surface of the dock 110.

In the example of FIG. 6, the aerial vehicle 101 may be closer to one portion of the safety envelope 130 and farther from an opposite portion of the safety envelope 130 while still over the dock 110, and an imaging sensor of the aerial vehicle 101 may detect all or most of a landing pad, e.g., having retroreflectors and/or indicia, present on an upper surface of the dock 110. When the aerial vehicle 101 is not substantially centered within the safety envelope 130, respective safety margins 132 between boundaries of the safety envelope 130 and portions of the aerial vehicle 101 closest to respective boundaries may be different around different portions of a periphery of the aerial vehicle 101. As shown in FIG. 6, the safety margin 132-1 shown on left side of the aerial vehicle 101 may be relatively smaller, and the safety margin 132-2 shown on right side of the aerial vehicle 101 may be relatively larger.

Although only safety margins 132-1, 132-2 associated with left and right sides of the aerial vehicle 101 are illustrated in FIG. 6, it is understood that the safety envelope 130 comprises a three-dimensional volume or shape within which the aerial vehicle 101 is operating, such that respective safety margins can be determined in multiple directions between portions of the aerial vehicle 101 and portions of the safety envelope 130 at an approximate altitude associated with a position of the aerial vehicle 101. For clarity of discussion, only a portion of the plurality of safety margins 132 associated with the three-dimensional safety envelope 130 are discussed herein.

Moreover, in order to determine a descent speed 136 of the aerial vehicle 101 during the second portion of the docking evolution, a smallest safety margin between any portion of the aerial vehicle 101 and any respective portion of the safety envelope 130 may be considered. In the example of FIG. 6, the safety margin 132-1 on the left side may be smaller than the safety margin 132-2 on the right side, and the safety margin 132-1 may also be assumed to be the smallest safety margin from among all safety margins 132 around the aerial vehicle 101. Thus, the smallest safety margin from among all safety margins 132 around the aerial vehicle 101 may comprise a value equal to the safety margin 132-1 between the aerial vehicle 101 and the portion of the safety envelope 130.

As a result, during the second portion of the docking evolution in which the aerial vehicle 101 is not substantially centered within the safety envelope 130, the descent speed 136 may be selected or determined to be a relatively slower descent speed, as compared to the highest or fastest descent speed 135 of FIG. 5, based on the value of the smallest safety margin from among all safety margins 132, i.e., safety margin 132-1, around the aerial vehicle 101. The relatively slower descent speed 136 is schematically illustrated in FIG. 6 by a relatively shorter arrow associated with descent speed 136. In this manner, descent speed of the aerial vehicle 101 toward the dock 110 may still remain relatively prioritized when the aerial vehicle 101 is not centered but remains within boundaries of the safety envelope 130 and over the dock 110, as well as an imaging sensor of the aerial vehicle 101 being able to detect all or most of a landing pad, e.g., having retroreflectors and/or indicia, present on an upper surface of the dock 110. Further, due to the relatively slower descent speed 136 when the aerial vehicle 101 is not centered within the safety envelope 130, continuous horizontal adjustment of the position of the aerial vehicle 101 within the safety envelope 130, e.g., as continuously instructed by lower level controllers of the aerial vehicle 101 during docking evolutions, may enable realigning the aerial vehicle 101 toward a center of the safety envelope 130 while avoiding or preventing the aerial vehicle 101 from moving further toward or outside boundaries of the safety envelope 130.

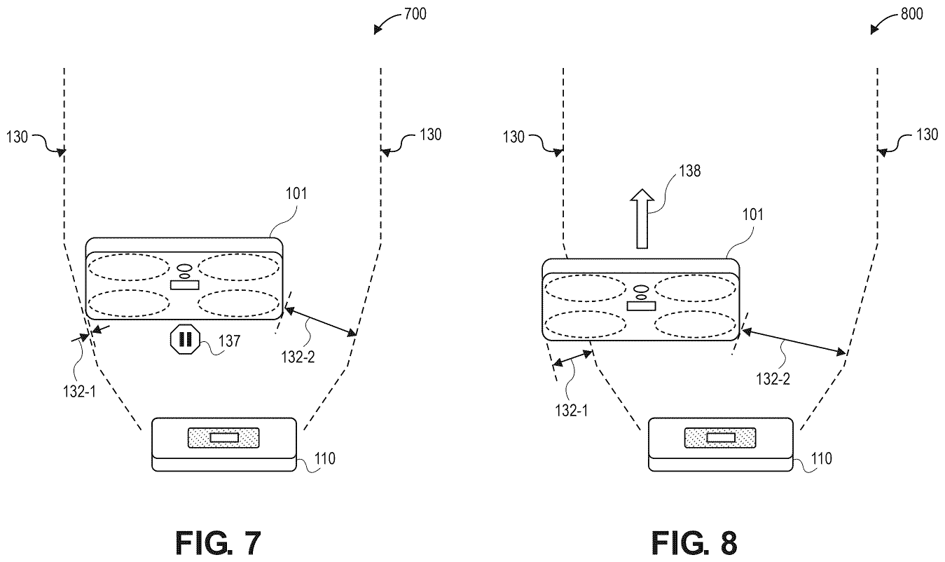

FIG. 7 is a schematic diagram 700 of an example docking method for aerial vehicles during a third portion, in accordance with implementations of the present disclosure.

As shown in FIG. 7, an example aerial vehicle 101 may be executing a third portion of a docking evolution to land on dock 110. The dock 110 may have an associated safety envelope 130 that extends vertically above the upper surface of the dock 110.

In the example of FIG. 7, the aerial vehicle 101 may be proximate to or in contact with one portion of the safety envelope 130, e.g., within a threshold distance or range of approximately 1 cm, approximately 2 cm, or other distances from the portion of the safety envelope, and still farther from an opposite portion of the safety envelope 130 while still over at least part of the dock 110, and an imaging sensor of the aerial vehicle 101 may detect some or only a portion of a landing pad, e.g., having retroreflectors and/or indicia, present on an upper surface of the dock 110. When the aerial vehicle 101 is close to or contacting the safety envelope 130, respective safety margins 132 between boundaries of the safety envelope 130 and portions of the aerial vehicle 101 closest to respective boundaries may be different around different portions of a periphery of the aerial vehicle 101. As shown in FIG. 7, the safety margin 132-1 shown on left side of the aerial vehicle 101 may be relatively smaller, e.g., approximately or close to zero, and the safety margin 132-2 shown on right side of the aerial vehicle 101 may be relatively larger.

Although only safety margins 132-1, 132-2 associated with left and right sides of the aerial vehicle 101 are illustrated in FIG. 7, it is understood that the safety envelope 130 comprises a three-dimensional volume or shape within which the aerial vehicle 101 is operating, such that respective safety margins can be determined in multiple directions between portions of the aerial vehicle 101 and portions of the safety envelope 130 at an approximate altitude associated with a position of the aerial vehicle 101. For clarity of discussion, only a portion of the plurality of safety margins 132 associated with the three-dimensional safety envelope 130 are discussed herein.

Moreover, in order to determine a descent speed 137 of the aerial vehicle 101 during the third portion of the docking evolution, a smallest safety margin between any portion of the aerial vehicle 101 and any respective portion of the safety envelope 130 may be considered. In the example of FIG. 7, the safety margin 132-1 on the left side, e.g., approximately or close to zero, may be smaller than the safety margin 132-2 on the right side, and the safety margin 132-1 may also be assumed to be the smallest safety margin from among all safety margins 132 around the aerial vehicle 101. Thus, the smallest safety margin from among all safety margins 132 around the aerial vehicle 101 may comprise a value equal to the safety margin 132-1 between the aerial vehicle 101 and the portion of the safety envelope 130.

As a result, during the third portion of the docking evolution in which the aerial vehicle 101 is proximate to or in contact with one portion of the safety envelope 130, the descent speed 137 may be selected or determined to be a further relatively slower descent speed, as compared to the descent speeds 135, 136 of FIGS. 5 and 6, based on the value of the smallest safety margin from among all safety margins 132, i.e., safety margin 132-1, around the aerial vehicle 101. The relatively slower descent speed 137 is schematically illustrated in FIG. 7 by a symbol that indicates pausing or stopping of descent of the aerial vehicle 101 toward the dock 110, e.g., a descent speed of approximately or close to zero. In this manner, descent speed of the aerial vehicle 101 toward the dock 110 may no longer be prioritized when the aerial vehicle 101 is proximate to or in contact with one portion of the safety envelope 130 and over a part of the dock 110, as well as an imaging sensor of the aerial vehicle 101 being able to detect some or only a portion of a landing pad, e.g., having retroreflectors and/or indicia, present on an upper surface of the dock 110. Further, due to the further relatively slower descent speed 137, e.g., pausing or stopping, when the aerial vehicle 101 is proximate to or in contact with one portion of the safety envelope 130, continuous horizontal adjustment of the position of the aerial vehicle 101 within the safety envelope 130, e.g., as continuously instructed by lower level controllers of the aerial vehicle 101 during docking evolutions, may be prioritized in order to realign the aerial vehicle 101 toward a center of the safety envelope 130 while avoiding or preventing the aerial vehicle 101 from moving further toward or outside boundaries of the safety envelope 130.

FIG. 8 is a schematic diagram 800 of an example docking method for aerial vehicles during a fourth portion, in accordance with implementations of the present disclosure.

As shown in FIG. 8, an example aerial vehicle 101 may be executing a fourth portion of a docking evolution to land on dock 110. The dock 110 may have an associated safety envelope 130 that extends vertically above the upper surface of the dock 110.

In the example of FIG. 8, the aerial vehicle 101 may be at least partially outside one or more boundaries of the safety envelope 130 and over some or no portion of the dock 110, and an imaging sensor of the aerial vehicle 101 may detect some or no portion of a landing pad, e.g., having retroreflectors and/or indicia, present on an upper surface of the dock 110. When the aerial vehicle 101 is at least partially outside boundaries of the safety envelope 130, respective safety margins 132 between boundaries of the safety envelope 130 and portions of the aerial vehicle 101 closest to respective boundaries may be different around different portions of a periphery of the aerial vehicle 101. As shown in FIG. 8, the safety margin 132-1 shown on left side of the aerial vehicle 101 may be a negative safety margin, e.g., a portion of the aerial vehicle 101 being outside the safety envelope 130, and the safety margin 132-2 shown on right side of the aerial vehicle 101 may be relatively larger.

Although only safety margins 132-1, 132-2 associated with left and right sides of the aerial vehicle 101 are illustrated in FIG. 8, it is understood that the safety envelope 130 comprises a three-dimensional volume or shape within which the aerial vehicle 101 is operating, such that respective safety margins can be determined in multiple directions between portions of the aerial vehicle 101 and portions of the safety envelope 130 at an approximate altitude associated with a position of the aerial vehicle 101. For clarity of discussion, only a portion of the plurality of safety margins 132 associated with the three-dimensional safety envelope 130 are discussed herein.

Moreover, in order to determine a speed 138 of the aerial vehicle 101 during the fourth portion of the docking evolution, a smallest safety margin between any portion of the aerial vehicle 101 and any respective port ion of the safety envelope 130 may be considered. In the example of FIG. 8, the safety margin 132-1 on the left side, e.g., a negative safety margin, may be smaller (or more negative) than the safety margin 132-2 on the right side, and the safety margin 132-1 may also be assumed to be the smallest safety margin from among all safety margins 132 around the aerial vehicle 101. Thus, the smallest safety margin from among all safety margins 132 around the aerial vehicle 101 may comprise a value equal to the safety margin 132-1 between the aerial vehicle 101 and the portion of the safety envelope 130.

As a result, during the fourth portion of the docking evolution in which the aerial vehicle 101 is at least partially outside one or more boundaries of the safety envelope 130, the speed 138 may be selected or determined to be a further slower descent speed, pausing or stopping, and/or an ascent speed that causes or instructs the aerial vehicle 101 to increase height or distance from the dock 110, based on the value of the smallest safety margin from among all safety margins 132, i.e., safety margin 132-1, around the aerial vehicle 101. The ascent speed 138 is schematically illustrated in FIG. 8 by an upwardly pointing arrow. In this manner, descent speed of the aerial vehicle 101 toward the dock 110 may no longer be prioritized and/or may be deprioritized when the aerial vehicle 101 is at least partially outside one or more boundaries of the safety envelope 130 and over some or none of the dock 110, as well as an imaging sensor of the aerial vehicle 101 being able to detect some or no portion of a landing pad, e.g., having retroreflectors and/or indicia, present on an upper surface of the dock 110. Further, due to the ascent speed 138 that increases height or distance from the dock 110 when the aerial vehicle 101 is at least partially outside one or more boundaries of the safety envelope 130, continuous horizontal adjustment of the position of the aerial vehicle 101 within the safety envelope 130, e.g., as continuously instructed by lower level controllers of the aerial vehicle 101 during docking evolutions, may be further prioritized in order to realign the aerial vehicle 101 toward a center of the safety envelope 130 while also increasing height to try to return the aerial vehicle 101 to within boundaries of the safety envelope 130. Moreover, by instructing ascent of the aerial vehicle 101 away from the landing pad and dock 110, the number of retroreflectors and/or indicia that are within a field of view of an imaging sensor of the aerial vehicle 101 may be increased, thereby further facilitating horizontal adjustment of the position of the aerial vehicle 101 within the safety envelope 130, as well as subsequent continuation or resumption of a docking evolution.

In additional example embodiments, the ascent speed described with respect to FIG. 8 may be selected or determined only if a portion of the safety envelope that is at an altitude above a current approximate altitude of the aerial vehicle includes a greater volume or greater horizontal extent. In such examples, ascent of the aerial vehicle may be instructed in order to facilitate movement or return of the aerial vehicle to a position that is within the boundaries of the safety envelope, e.g., because of the greater volume or greater horizontal extent of the safety envelope at a greater altitude, together with continuous horizontal adjustment of the position of the aerial vehicle to try to return the aerial vehicle to a position that is within the boundaries of the safety envelope at the current approximate altitude. Correspondingly, ascent of the aerial vehicle may not be instructed if the safety envelope does not include a greater volume or greater horizontal extent at an altitude above a current approximate altitude of the aerial vehicle. Instead, descent of the aerial vehicle may be slowed, paused, or stopped, and the continuous horizontal adjustment of the position of the aerial vehicle may be prioritized to try to return the aerial vehicle to a position that is within the boundaries of the safety envelope at the current approximate altitude.

In example embodiments, safety margins between portions of an aerial vehicle 101 and portions of a safety envelope 130 may be determined based on a calculated or determined pose of the aerial vehicle 101 relative to the dock 110, e.g., continuously, at a defined frequency, and/or at other intervals during a docking evolution. For example, the pose, e.g., position and orientation in four, five, or six degrees of freedom, of the aerial vehicle 101 may be determined using various methods. In some examples, a flight controller or other controller of the aerial vehicle 101 may determine a pose based on data from various onboard sensors, such as inertial measurement units (IMUs), vehicle dynamics sensors, or other sensors. In other examples, a flight controller or other controller of the aerial vehicle 101 may determine a pose based at least in part on stored or received map data associated with an environment and known or estimated positions or locations of aerial vehicles and docks in the environment. In additional examples, a flight controller or other controller of the aerial vehicle 101 may determine a pose based on data from various imaging sensors or vision systems, e.g., one or more cameras, depth sensors, or other imaging or ranging sensors or devices having various fields of view around the aerial vehicle. In such cases, imaging data may be processed to identify known objects, landmarks, markers, or indicia within the imaging data, and a flight controller or other controller of the aerial vehicle 101 may determine a pose based on processing of such known objects, markers, or indicia.

For example, based on detection of retroreflectors, markers, or indicia associated with a landing pad of a dock, a flight controller or other controller of the aerial vehicle 101 may determine a pose relative to the identified and processed retroreflectors, markers, or indicia of the landing pad. Various other types of positioning, orientation, localization, mapping, or other pose determination systems or methods may be used to determine a pose of an aerial vehicle 101 relative to a dock 110, and thereby determine safety margins between portions of the aerial vehicle 101 and portions of the safety envelope 130 associated with the dock 110.

As described herein, the example control strategy causes or instructs high level flight, navigation, trajectory planning, or other controllers of an aerial vehicle 101 to control substantially only height, altitude, vertical position, vertical velocity, and/or vertical acceleration of the aerial vehicle 101 during docking evolutions. In addition, the example control strategy may generally not directly control or instruct lower level controllers, such as motor controllers, of the aerial vehicle 101 that may receive and implement control commands received from the high level flight, navigation, trajectory planning, or other controllers.

Further, the example control strategy may generally not cause or instruct the high level flight, navigation, trajectory planning, or other controllers of the aerial vehicle 101 to control horizontal position, speed, or acceleration of the aerial vehicle 101. Instead, the horizontal position, speed, or acceleration of the aerial vehicle 101 may already be controlled by the flight, navigation, trajectory planning, or other controllers to maintain and adjust the aerial vehicle 101 to a desired horizontal position, e.g., substantially centered over a dock 110 during docking evolutions. Moreover, because the flight, navigation, trajectory planning, or other controllers are already operating to maintain the aerial vehicle 101 at a desired horizontal position, additional high level control commands to perform the same functions or operations may be substantially redundant and/or unnecessary.

For particular configurations of aerial vehicles, such as quadcopters, hexacopters, octocopters, or other similar configurations having propellers that rotate substantially with a same horizontal plane or parallel horizontal planes, the example control strategy may be relatively simple and intuitive to implement. Such configurations of aerial vehicles may result in relatively simple and straightforward control or adjustment of vertical height, altitude, velocity, and/or acceleration by corresponding operation of the motors and propellers. Thus, the example control strategy may leverage the physical configuration or arrangement of various aerial vehicles to provide a relatively straightforward method to enable reliable and efficient control and performance of docking evolutions.

As described herein, during a docking evolution, an aerial vehicle may have a descent speed that is related to or based at least in part on a smallest safety margin between portions of the aerial vehicle and portions of the safety envelope. Thus, when the smallest safety margin is a maximum value, e.g., the aerial vehicle is substantially centered within the safety envelope, the descent speed may be 100% of a maximum or target descent speed. When the smallest safety margin is a different value between approximately zero and the maximum value, e.g., the aerial vehicle is not centered but remains within the safety envelope, the descent speed may be some percentage less than 100% of the maximum or target descent speed, in which the percentage is a value between 0% and 100% that is correlated with or based on the smallest safety margin. In addition, when the smallest safety margin is approximately zero, e.g., the aerial vehicle is proximate to or in contact with a portion of the safety envelope, the descent speed may be approximately 0% of the maximum or target descent speed, i.e., the aerial vehicle may pause or stop vertical descent. Moreover, when the smallest safety margin is a negative value less than zero, e.g., the aerial vehicle is at least partially outside the safety envelope, an ascent speed may be determined that is some percentage less than or up to 100% of a maximum or target ascent speed, in which the percentage is a value between 0% and 100% that is correlated with or based on the smallest safety margin.

In one example embodiment of the example control strategy, a change in vertical position or altitude, Δz, may be calculated to control or instruct an aerial vehicle during a docking evolution using the following Equation 1:

$$Δ z = max ( - r , min ( 1 , {M}_{current} / {M}_{ideal} ) ) * Δ {z}_{p} \qquad ( 1 )$$

Generally, Δz may be positive in a direction associated with descent toward a dock, e.g., vertically downward movement. Correspondingly, Δz may be negative in a direction associated with ascent away from a dock, e.g., vertically upward movement. M_{current} may correspond to a smallest safety margin associated with a current position of the aerial vehicle relative to boundaries of the safety envelope associated with the dock, and M_{ideal} may correspond to a largest safety margin associated with an ideal position of the aerial vehicle that is substantially centered within the safety envelope. In addition, Δzₚ may comprise a configurable, predefined constant value associated with a maximum change in vertical position or altitude in a vertically downward direction, e.g., a maximum descent speed. Further, −r may comprise a configurable, predefined constant value associated with a maximum change in vertical position or altitude in a vertically upward direction, e.g., a maximum ascent speed.

As can be seen from Equation 1, if M_{current} is equal to M_{ideal}, i.e., the aerial vehicle is substantially centered within the safety envelope, M_{current}/M_{ideal} may be equal to the value of 1, such that a minimum (“min” function) of 1 or M_{current}/M_{ideal} is equal to 1. Then, a maximum (“max” function) of −r and 1 is equal to 1, and the value of Δz is equal to 1 times Δzₚ. As a result, the aerial vehicle may be instructed to descend at a maximum descent speed.

Similarly from Equation 1, if M_{current} is a value less than M_{ideal}, i.e., the aerial vehicle is not centered but remains within the safety envelope, M_{current}/M_{ideal} may be equal to a value less than 1, which can be referred to as a proportional value P. A minimum (“min” function) of 1 or M_{current}/M_{ideal} is equal to the value P. Then, a maximum (“max” function) of −r and the value P is equal to the value P, and the value of Δz is equal to the value P times Δzₚ. As a result, the aerial vehicle may be instructed to descend at a proportional value P of maximum descent speed that is less than the maximum descent speed.

Again referring to Equation 1, if M_{current} is a value less than M_{ideal} and approximately zero, i.e., the aerial vehicle is contacting a portion of the safety envelope, M_{current}/M_{ideal} may be equal to a value of zero, such that a minimum (“min” function) of 1 or M_{current}/M_{ideal} is equal to zero. Then, a maximum (“max” function) of −r and zero is equal to zero, and the value of Δz is equal to zero times Δzₚ. As a result, the aerial vehicle may be instructed to pause, stop, or maintain a current vertical position or altitude, e.g., operate with a descent speed of zero.

Further from Equation 1, if M_{current} is a negative value less than M_{ideal}, i.e., the aerial vehicle is at least partially outside the safety envelope, M_{current}/M_{ideal} may be equal to a negative value less than 1, which can be referred to as a negative proportional value −P. A minimum (“min” function) of 1 or M_{current}/M_{ideal} is equal to the value −P. Then, a maximum (“max” function) of −r and the value −P is equal to the value −P if the value −P is greater, i.e., less negative, than the value −r, and the value of Δz is equal to the value −P times Δzₚ. As a result, the aerial vehicle may be instructed to ascend at a proportional value −P of the maximum descent speed that is less than the maximum ascent speed.

Moreover, the ascent speed may be limited to a maximum value associated with the value −r. Thus, if the value −P is less, i.e., more negative, than the value −r, a maximum (“max” function) of −r and the value −P is equal to the value −r, and the value of Δz is equal to the value −r times Δzₚ. As a result, the aerial vehicle may be instructed to ascend at a value −r times the maximum descent speed, which may constitute a maximum ascent speed.

Although Equation 1 describes the example control strategy in terms of calculating or determining a change in vertical position or altitude, Δz, during a docking evolution, other example embodiments may describe or define the example control strategy in terms of calculating or determining a change in vertical velocity or speed during a docking evolution. Thus, rather than determining setpoints associated with vertical position or altitude as described in Equation 1, the example control strategy may instead determine setpoints associated with vertical velocities or speeds, e.g., descent or ascent speeds. Moreover, lower level controllers may instruct rotational velocities of individual motors and propellers of an aerial vehicle to achieve the desired descent or ascent speeds according to the example control strategy.

Moreover, although Equation 1 describes the example control strategy as utilizing a current safety margin, e.g., determined or calculated based on a current pose of an aerial vehicle relative to a dock, further example embodiments may describe or define the example control strategy as predicting, calculating, or determining a predicted safety margin, e.g., predicted based on a current pose of an aerial vehicle relative to a dock, that may be associated with a future state or pose of the aerial vehicle. For example, because the aerial vehicle is operating and in motion, a predicted safety margin may enable more reliable and accurate control that may take into account various processing, control, or other delays or latency associated with the example control strategy. In some cases, a predicted safety margin may be determined that may be approximately 100 ms, approximately 150 ms, approximately 200 ms, or other values of time in the future relative to a current state or pose.

In alternative example embodiments, various other equations, calculations, or determinations may be used to implement the example control strategy other than the formulation associated with Equation 1. For example, various other bounds or limits may be associated with descent speed and/or ascent speed during docking evolutions. In addition, relationships other than proportional values or ratios between current or predicted safety margins and ideal safety margins may be used to determine changes to vertical position, altitude, or velocity that are to be instructed based on the safety margins.

Various other changes may be made to the formulation associated with Equation 1, while still satisfying at least the first objective to maintain an aerial vehicle within boundaries of a safety envelope during a docking evolution, and at least the second objective to maintain a landing pad of a dock within a field of view of an imaging sensor of the aerial vehicle. Moreover, various other equations, calculations, or determinations may be used to implement control strategies that prioritize descent speed when an aerial vehicle remains within a safety envelope during docking evolutions, and that prioritize horizontal adjustment, e.g., by pausing descent or instructing ascent, when an aerial vehicle reaches or extends outside of a safety envelope during docking evolutions.

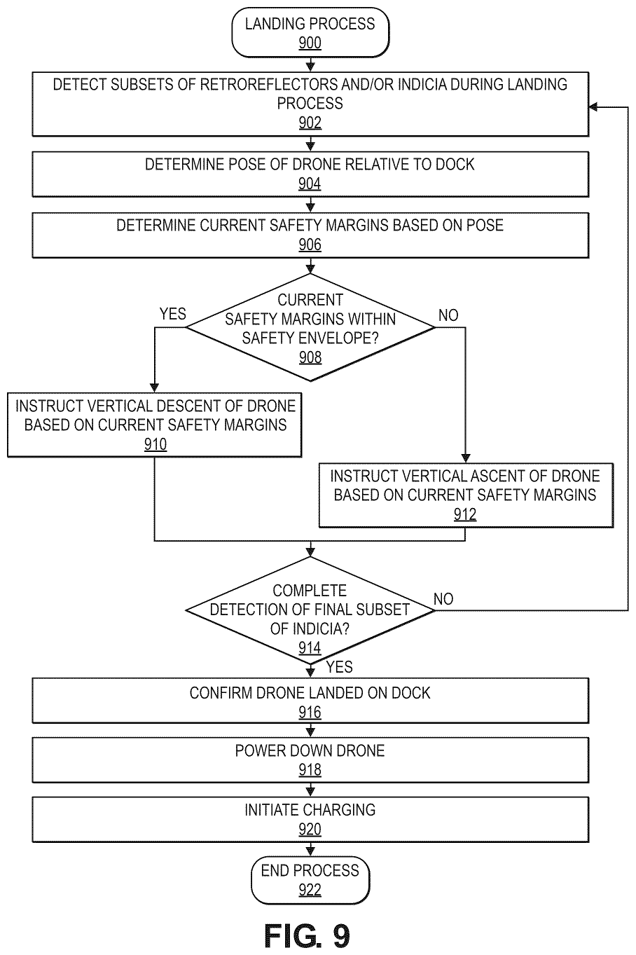

FIG. 9 is a flow diagram illustrating an example landing process 900, in accordance with implementations of the present disclosure.

The process 900 may begin by detecting subsets of retroreflectors and/or indicia during a landing process, as at 902. For example, an aerial vehicle may determine to initiate a docking or landing process at a dock, and the aerial vehicle may navigate toward a location of the dock, e.g., a known position within an indoor space. In addition, the aerial vehicle may actuate a light source and sensor, e.g., an imaging sensor, to detect portions of a landing pad of the dock, as further described herein. The imaging sensor may capture imaging data of subsets of retroreflectors and/or indicia placed, positioned, or adhered to a landing pad of the dock. Various retroreflectors and/or indicia may be configured for detection at different respective heights of the aerial vehicle relative to the dock corresponding to respective phases or stages of a docking process or evolution. Further, a control system associated with the aerial vehicle may instruct detection, by the light source and imaging sensor, of the subsets of retroreflectors and/or indicia of the landing pad during the docking or landing process or evolution.

The process 900 may continue by determining a pose of the drone relative to the dock, as at 904. For example, the pose may be determined or calculated using various data or information, such as data from IMUs, vehicle dynamics sensors, vision systems, imaging sensors, or other positioning, localization, or mapping sensors, devices, or algorithms. In some examples, the pose of the aerial vehicle relative to the dock may be determined by processing the subsets of retroreflectors and/or indicia presented on the landing pad and captured within imaging data. The pose of the aerial vehicle may comprise four, five, or six degrees of freedom of position and/or orientation of the aerial vehicle relative to the dock. At a minimum, the pose of the aerial vehicle may comprise a horizontal position of the aerial vehicle relative to a center of the landing pad and/or dock, as well as a vertical height or distance between the aerial vehicle and the landing pad and/or dock. The pose of the aerial vehicle may preferably also comprise a relative orientation of the aerial vehicle around a vertical axis relative to the landing pad and/or dock, e.g., a yaw orientation of the aerial vehicle relative to the dock. Further, a control system associated with the aerial vehicle may determine a pose of the aerial vehicle relative to the dock.

The process 900 may proceed by determining current safety margins based on the pose, as at 906. For example, based on the determined pose, current safety margins between portions of the aerial vehicle and portions of boundaries of a safety envelope associated with the dock may be determined. Generally, a smallest safety margin associated with a portion of the aerial vehicle relative to a portion of the boundaries of the safety envelope may be utilized or selected as a current safety margin for purposes of the landing process, as further described herein. Thus, if the aerial vehicle is substantially centered within the safety envelope, the current safety margin may comprise a largest possible safety margin. As the aerial vehicle approaches a portion of the boundaries of the safety envelope, the current safety margin may decrease from the largest possible safety margin. Further, when the aerial vehicle contacts a portion of the boundaries of the safety envelope, the current safety margin may be substantially zero. Moreover, if the aerial vehicle navigates outside a portion of the safety envelope, the current safety margin may become a negative value, with the negative value becoming more negative as the aerial vehicle navigates further from a center of the safety envelope. Further, a control system associated with the aerial vehicle may determine a current safety margin based on the determined pose of the aerial vehicle relative to the dock.

The process 900 may then continue to determine whether the current safety margins are within the safety envelope, as at 908. For example, it may be determined whether the current safety margin is a positive value, such that the aerial vehicle remains within the safety envelope, or whether the current safety margin is a negative value, such that the aerial vehicle has navigated at least partially outside the safety envelope. Further, a control system associated with the aerial vehicle may determine whether the current safety margin is within the safety envelope.

If it is determined that the current safety margin is within the safety envelope, the process 900 may proceed to instruct vertical descent of the drone based on the current safety margins, as at 910. For example, a vertical position, altitude, velocity, and/or changes thereof for descent toward the dock may be determined or calculated based on the current safety margin. As described herein, an example control strategy may prioritize descent speed while the aerial vehicle remains within the safety envelope. In addition, the descent speed may vary based on the current safety margin, e.g., between a maximum descent speed and a minimum descent speed, which may include a descent speed of zero or hovering operation. Further, a control system associated with the aerial vehicle may instruct vertical descent of the aerial vehicle based on the current safety margin.

If, however, it is determined that the current safety margin is not within the safety envelope, the process 900 may continue with instructing vertical ascent of the drone based on the current safety margins, as at 912. For example, a vertical position, altitude, velocity, and/or changes thereof for pausing descent and/or instructing ascent away from the dock may be determined or calculated based on the current safety margin. As described herein, when an aerial vehicle is at least partially outside boundaries of a safety envelope, an example control strategy may deprioritize descent speed and instead prioritize horizontal position until the aerial vehicle returns to within the safety envelope. In addition, the ascent speed may vary based on the current safety margin, e.g., between a maximum ascent speed and a minimum ascent speed, which may include an ascent speed that is close to or slightly above zero. Further, a control system associated with the aerial vehicle may instruct vertical ascent of the aerial vehicle based on the current safety margin.

After instructing vertical descent at step 910 or after instructing vertical ascent at step 912, the process 900 may then proceed with determining whether there is a complete detection of a final subset of indicia, as at 914. For example, a final subset of indicia, e.g., comprising one of the plurality of subsets of retroreflectors and/or indicia, of the landing pad of the dock may be associated with completion or substantial completion of a docking or landing process or evolution of the aerial vehicle with the dock. In addition, the imaging sensor of the aerial vehicle may capture imaging data of the final subset of indicia placed, positioned, or adhered to the landing pad of the dock. As part of the detection of the markers, the imaging data may also be processed to determine a pose of the aerial vehicle relative to the landing pad and/or dock, e.g., based on detected portions, corners, or edges of one or more markers within the imaging data. Further, a control system associated with the aerial vehicle may instruct detection, by the light source and imaging sensor, of the final subset of indicia of the landing pad during the docking or landing process or evolution.

If it is determined that the final subset of indicia is not completely detected, the process 900 may return to step 902 to continue to detect various subsets of the retroreflectors and/or indicia during the docking or landing process or evolution.

If, however, it is determined that the final subset of indicia is completely detected, the process 900 may continue by confirming that the drone has landed on the dock, as at 916. For example, an electrical connector of the aerial vehicle may engage, couple, or otherwise connect with a corresponding connector of the dock to facilitate transmission of data, power, and/or other aspects between the aerial vehicle and the dock, and such successful communication between the aerial vehicle and the dock may provide confirmation of the docking evolution. In addition, one or more sensors may be associated with the aerial vehicle and/or the dock to detect contact or engagement, such as contact sensors, presence detection sensors, pressure or weight sensors, imaging sensors, or other types of sensors. Various other sensors, devices, or methods may be used to confirm that the aerial vehicle has landed on the dock. Further, a control system associated with the aerial vehicle and/or dock may confirm completion of the docking evolution.

The process 900 may then proceed by powering down the drone, as at 918. For example, motors and propellers of the aerial vehicle may be powered down, flight, navigation, trajectory planning, and other controllers of the aerial vehicle may be powered down, various other actuators and/or sensors of the aerial vehicle may be powered down, and/or various electrical, mechanical, or other components of the aerial vehicle may be powered down. Further, a control system associated with the aerial vehicle and/or dock may power down portions of the aerial vehicle.

The process 900 may continue to initiate charging, as at 920. For example, via the connection between the electrical connector of the aerial vehicle and the corresponding connector of the dock, power may be transmitted to charge one or more onboard power sources of the aerial vehicle. In addition, various data may be transmitted between the aerial vehicle and the dock, including transmitting various flight, navigation, operational, sensor, and/or other data from the aerial vehicle to the dock, as well as transmitting various software routines, updates, models or algorithms, flight plans, tasks, or operations, control commands or instructions, and/or various other data from the dock to the aerial vehicle. Various other types of data or information may be transmitted between the aerial vehicle and the dock. Further, a control system associated with the aerial vehicle and/or dock may initiate charging and other processes.

The process 900 may then end, as at 922.

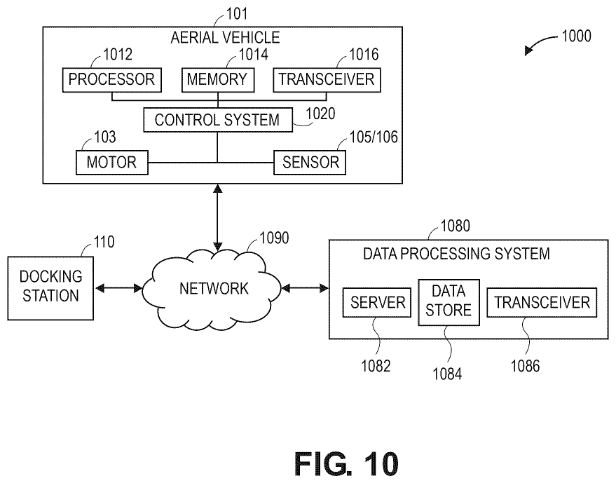

FIG. 10 is a block diagram 1000 illustrating an example system including an aerial vehicle and dock, in accordance with implementations of the present disclosure.

Referring to FIG. 10, a block diagram of components of an example system including an aerial vehicle and docking station in accordance with embodiments of the present disclosure is shown. The system 1000 includes an aerial vehicle 101, a docking station 110, and a data processing system 1080 that are connected to one another across a network 1090, which may include the Internet in whole or in part.

The aerial vehicle 101 may be any type or form of aerial vehicle (e.g., an unmanned aerial vehicle, or drone), as described herein, that may be programmed or configured to autonomously perform one or more operations within indoor spaces of a facility. As is shown in FIG. 10, the aerial vehicle 101 may include a processor 1012, a memory 1014, and a transceiver 1016. The aerial vehicle 101 may further include a control system 1020, one or more motors 103, one or more sensors 105, and one or more light sources 106.

The processor 1012 may be configured to perform any type or form of computing function associated with the operation of the aerial vehicle 101. For example, the processor 1012 may be configured to execute any algorithms or techniques (e.g., machine learning systems or techniques) associated with one or more applications, purposes, or functions, such as navigation, monitoring, or collision avoidance, or to select at least one of a course, a speed, or an altitude for the safe operation of the aerial vehicle 101. The processor 1012 may be configured to control any aspects of the operation of the aerial vehicle 101 and any computer-based components thereon, including but not limited to the motors 103, the sensors 105, or the light sources 106. For example, the processor 1012 may control the operation of one or more control systems or modules, such as the control system 1020, for generating instructions for conducting operations of one or more of the motors 103, the sensors 105, or the light sources 106. Such control systems or modules may be associated with one or more other computing devices or machines, and may communicate with the docking station 110, the data processing system 1080, or one or more other computer devices over the network 1090, through the sending and receiving of digital data.

The processor 1012 may be a uniprocessor system including one processor, or a multiprocessor system including several processors (e.g., two, four, eight, or another suitable number), and may be capable of executing instructions. For example, in some embodiments, the processor 1012 may be a general-purpose or embedded processor unit such as a CPU or a GPU having any number of instruction set architectures (ISAs), such as the x86, PowerPC, SPARC, or MIPS ISAs, or any other suitable ISA. Where the processor 1012 is a multiprocessor system, each of the processors within the multiprocessor system may operate the same ISA, or different ISAs.

Additionally, the aerial vehicle 101 further includes one or more memory or storage components 1014 (such as databases or data stores) for storing any type of information or data, e.g., instructions for operating the aerial vehicle 101, or information or data captured during operations of the aerial vehicle 101. The memory 1014 may be configured to store executable instructions, imaging data, paths or routes, control parameters, and/or other data items accessible by or to the processor 1012. The memory 1014 may be implemented using any suitable memory technology, such as random-access memory (or “RAM”), static RAM (or “SRAM”), synchronous dynamic RAM (or “SDRAM”), non-volatile/Flash-type memory, or any other type of memory. In some embodiments, program instructions, imaging data, flight paths, flight control parameters, and/or other data items may be received or sent via the transceiver 1016, e.g., by transmission media or signals, such as electrical, electromagnetic, or digital signals, which may be conveyed via a communication medium such as a wired and/or a wireless link.

The transceiver 1016 may be configured to enable the aerial vehicle 101 to communicate through one or more wired or wireless means, e.g., wired technologies such as Universal Serial Bus (or “USB”) or fiber optic cable, or standard wireless protocols or standards such as Bluetooth® or any Wi-Fi® protocol, over the network 1090 or directly. The transceiver 1016 may further include or be in communication with one or more input/output (or “I/O”) interfaces, and may be configured to allow information or data to be exchanged between one or more of the components of the aerial vehicle 101, or to one or more other computer devices or systems (e.g., other aerial vehicles, not shown) via the network 1090. For example, in some embodiments, the transceiver 1016 may be configured to coordinate I/O traffic between the processor 1012 and one or more onboard or external computer devices or components, e.g., the control system 1020, or the motors 103, the sensors 105, or the light sources 106. The transceiver 1016 may perform any necessary protocol, timing, or other data transformations in order to convert data signals from a first format suitable for use by one component into a second format suitable for use by another component. In some embodiments, the transceiver 1016 may include support for devices attached through various types of peripheral buses, e.g., variants of the Peripheral Component Interconnect (PCI) bus standard or the Universal Serial Bus (USB) standard. In some other embodiments, functions of the transceiver 1016 may be split into two or more separate components, or integrated with the processor 1012.

The control system 1020 may further include one or more electronic speed controls, power supplies, navigation systems, and/or payload engagement controllers for controlling the operation of the aerial vehicle 101 and for engaging with or releasing items, as desired. For example, the control system 1020 may be configured to cause or control the operation of one or more of the motors 103, e.g., to cause one or more of the motors 103 to operate at desired speeds, in order to guide the aerial vehicle 101 along a desired course, at a desired speed, or at a desired altitude, as appropriate. The control system 1020 may further control any other aspects of the aerial vehicle 101, including but not limited to the operation of one or more control surfaces such as wings, rudders, flaperons, elevons, elevators, ailerons, flaps, brakes, or slats of an aerial vehicle, within desired ranges. In some embodiments, the control system 1020 may be integrated with one or more of the processor 1012, the memory 1014, and/or the transceiver 1016.

The motors 103 may be any type or form of motor (e.g., electric, gasoline-powered, or any other type of motor) capable of generating sufficient rotational speeds of one or more propellers or other components to provide thrust and/or lift forces to the aerial vehicle 101 and any payload engaged thereby. In some embodiments, one or more of the motors 103 may be a brushless direct current (“DC”) multi-phase motor such as an outrunner brushless motor or an inrunner brushless motor.

The aerial vehicle 101 may include any number of such motors 103 of any kind. For example, one or more of the motors 103 may be aligned or configured to operate with different capacities or ratings, or at different speeds, or coupled to any number of propellers having different sizes and shapes. Additionally, one or more of the motors 103 may be an electric motor, e.g., a brushless DC multi-phase motor, and one or more of the motors 103 may be a gasoline-powered motor.

The aerial vehicle 101 may also include any number of sensors 105, light sources 106, or other components or other features for capturing data within a vicinity of the aerial vehicle 101, including but not limited to one or more imaging devices (e.g., digital cameras), range sensors (e.g., LIDAR sensors, time-of-flight sensors, ultrasonic sensors, or others), radiofrequency transceivers or receivers, Global Positioning System (“GPS”) receivers or sensors, compasses, speedometers, altimeters, thermometers, barometers, hygrometers, gyroscopes, air monitoring sensors (e.g., oxygen, ozone, hydrogen, carbon monoxide, or carbon dioxide sensors), ozone monitors, pH sensors, magnetic anomaly detectors, metal detectors, radiation sensors (e.g., Geiger counters, neutron detectors, alpha detectors), attitude sensors, depth gauges, accelerometers, or sound sensors (e.g., microphones, piezoelectric sensors, vibration sensors, or other transducers for detecting and recording acoustic energy from one or more directions). For example, in some implementations, the aerial vehicle 101 may include two or more of such sensors 105 in an IMU or any other system. Furthermore, in some implementations, one or more of the sensors 105 may have fields of view or other orientations or configurations that enable the aerial vehicle 101 to capture information or data from below the aerial vehicle 101, or in any other direction with respect to the aerial vehicle 101. For example, in some implementations, the aerial vehicle 101 may include one or more cameras that are aligned to capture imaging data from fields of view extending below the aerial vehicle 101, and along or parallel to a yaw axis of the aerial vehicle 101. Alternatively, the aerial vehicle 101 may include one or more cameras that are aligned to capture imaging data from fields of view extending laterally with respect to the aerial vehicle 101, e.g., perpendicular to a yaw axis of the aerial vehicle 101, or along or parallel to a pitch axis or a roll axis of the aerial vehicle 101.

Although the block diagram of FIG. 10 includes a single box corresponding to a motor 103 and a single box corresponding to a sensor 105 and/or a light source 106, those of ordinary skill in the pertinent arts will recognize that the aerial vehicle 101 may include any number of motors 103, sensors 105, or light sources 106 in accordance with the present disclosure.

The docking station 110 may be any device or system configured to receive portions of the aerial vehicle 101 therein or thereon, e.g., prior to or following operations of the aerial vehicle 101, and to support weight of the aerial vehicle 101, or provide power or connectivity to the aerial vehicle 101. The docking station 110 may include frames or housings formed from any suitable materials, as well as contacts (or connectors, e.g., charging contacts or charging connectors) for transferring power or data to or from the aerial vehicle 101. The docking station 110 may be formed from any suitable materials, and may have sizes, shapes, or dimensions that are selected based on attributes or features of the aerial vehicle 101, in accordance with any of the implementations described herein.

In some implementations, the docking station 110 may include one or more transceivers or other components or systems for enabling communication between the aerial vehicle 101, the data processing system 1080, or any other systems (not shown). Alternatively, in some other implementations, the docking station 110 need not include any such components or systems.

The data processing system 1080 includes one or more physical computer servers 1082 having one or more computer processors, one or more data stores (e.g., databases) 1084, and any number of transceivers 1086 associated therewith, as well as provided for any specific or general purpose. In some embodiments, the data processing system 1080 of FIG. 10 may be independently provided for the exclusive purpose of receiving, analyzing, or storing information or data received from the aerial vehicle 101 or, alternatively, provided in connection with one or more physical or virtual services configured to receive, analyze, or store such information or data, as well as one or more other functions. In some other embodiments, the data processing system 1080 may be associated with an electronic marketplace, a fulfillment center, a warehouse, a bricks-and-mortar retail establishment, or any other like facilities. Such facilities may be adapted to receive, store, process, and/or distribute items, and may include any number of stations for receiving, storing, and distributing items to customers, including but not limited to one or more receiving stations, storage areas, and/or distribution stations, which may further include any number of associated servers, data stores, processors, or like computer components. Alternatively, or additionally, in some embodiments, the data processing system 1080 may be associated with any number of public or private authorities, such as police, fire, or security personnel.

The servers 1082 may be connected to or otherwise communicate with the data stores 1084 and the transceivers 1086, and may receive, analyze, or store any type of information or data, e.g., imaging data, acoustic signals, environmental conditions, operational characteristics, pose data, safety envelopes, safety margins, descent speeds, ascent speeds, or any other information or data, for any purpose. The servers 1082 and/or the data stores 1084 may also connect to or otherwise communicate with the network 1090, through the sending and receiving of digital data. In some embodiments, the data processing system 1080 may be provided in a physical location. In other such embodiments, the data processing system 1080 may be provided in one or more alternate or virtual locations, e.g., in a “cloud” based environment. In still other embodiments, the data processing system 1080 may be provided onboard one or more vehicles, including but not limited to the aerial vehicle 101.

Each of the transceivers 1016, 1086 or other communications devices, systems, or components may be configured to communicate through one or more wired or wireless means, e.g., wired technologies such as Universal Serial Bus (or “USB”) or fiber optic cable, or wireless standards or protocols such as Bluetooth® or any Wi-Fi® protocol, over the network 1090 or directly. The transceivers 1016, 1086 may further include or be in communication with one or more I/O interfaces, network interfaces, or devices, and may be configured to allow information or data to be exchanged between one another, or to or from one or more other computer devices or systems via the network 1090.

The transceivers 1016, 1086 may perform any necessary protocol, timing, or other data transformations in order to convert data signals from a first format suitable for use by one component into a second format suitable for use by another component. For example, in some embodiments, the transceivers 1016, 1086 may be configured to communicate according to one or more protocols traditionally associated with discrete components, e.g., within specific frequency spectra, including but not limited to radio frequency signals typically within ranges of approximately three hundred to four hundred megahertz, or MHz, as well as radio frequency signals typically within ranges of approximately three hundred to five hundred megahertz, or MHz.

In some embodiments, the transceivers 1016, 1086 may be configured to transmit or receive Bluetooth® signals sent within an industrial, scientific, and medical (ISM) radio frequency range of approximately 2.400 to approximately 2.500 gigahertz (GHz), with a center frequency of approximately 2.450 GHz. Such signals are typically sent within a particular range of approximately 2.402 to approximately 2.480 GHz, and have a maximum transmission rate on Bluetooth® networks of 3 megabits per second (or 3 Mbps) or more, with a maximum transmission range of 10 to 100 meters or more, and at powers of approximately one milliwatt (mW), or 0.001 watts (W). The transceivers 1016, 1086 may operate according to a frequency-hopping spread spectrum (FHSS) method, e.g., by switching carriers across multiple frequency channels and transmitting communications in small segments, and in respective time slots. In some embodiments, such communications may be transmitted at approximately 1,600 times per second across 79 different subfrequencies at bandwidths of 0.001 GHz, or one megahertz (MHz) across the 2.402 to 2.480 GHz range.

In some embodiments, the transceivers 1016, 1086 may be configured to transmit or receive Ultra-Wide Band (or “UWB”) signals over one or more broad spectrums within any radio frequency range. In some embodiments, the UWB signals may be transmitted and/or received over a range of approximately three to eleven gigahertz (GHz), or over a range of approximately four to six gigahertz (GHz), with a center frequency of approximately five gigahertz (GHz). Alternatively, the UWB signals may be transmitted over any frequency range, and with any center frequency. Additionally, the UWB signals may consist of billions of pulses transmitted across such frequency spectrums, and at various power levels or power densities.

In some embodiments, the transceivers 1016, 1086 may be configured to transmit or receive RFID signals at low frequency (LF), medium frequency (MF), or high frequency (HF) levels (e.g., approximately 3 kilohertz to 30 megahertz, or 3 kHz-30 MHz) and transfer relatively small-sized sets or packets of data over short ranges (e.g., between one and one hundred centimeters, or 1-100 cm). In some other embodiments, the transceivers 1016, 1086 may be configured to transmit or receive RFID signals at higher frequency levels, such as ultrahigh frequency (UHF) or microwave levels (e.g., approximately 300 megahertz to 300 gigahertz, or 300 MHz-300 GHz) including larger sets or packets of data at ranges of one meter (1 m) or longer.

Alternatively, the transceivers 1016, 1086 may be configured to communicate within customized frequency spectra, or at dynamic frequencies, in accordance with the present disclosure. For example, in some embodiments, one or more of the transceivers 1016, 1086 may be configured to communicate according to a proprietary standard or protocol, or within a proprietary frequency spectrum.

In some embodiments, the transceivers 1016, 1086 may include support for devices attached through various types of peripheral buses, e.g., variants of the Peripheral Component Interconnect (PCI) bus standard or the Universal Serial Bus (USB) standard. In some other embodiments, functions of the transceivers 1016, 1086 may be split into two or more separate components, or incorporated directly into one or more processors or other components.

The network 1090 may be any wired network, wireless network, or combination thereof, and may comprise the Internet in whole or in part. In addition, the network 1090 may be a personal area network, local area network, wide area network, cable network, satellite network, cellular telephone network, or combination thereof. The network 1090 may also be a publicly accessible network of linked networks, possibly operated by various distinct parties, such as the Internet. In some embodiments, the network 1090 may be a private or semi-private network, such as a corporate or university intranet. The network 1090 may include one or more wireless networks, such as a Global System for Mobile Communications (GSM) network, a Code Division Multiple Access (CDMA) network, a Long-Term Evolution (LTE) network, or some other type of wireless network. Protocols and components for communicating via the Internet or any of the other aforementioned types of communication networks are well known to those skilled in the art of computer communications and thus, need not be described in more detail herein. Any combination of networks or communications protocols may be utilized in accordance with the systems and methods of the present disclosure. For example, the various components described herein may be configured to communicate via an open or standard protocol such as Wi-Fi®. Alternatively, such components may be configured to communicate with one another directly outside of a centralized network, such as the network 1090, e.g., by a wireless protocol such as Bluetooth®, in which two or more of such components may be paired with one another.

The computers, servers, devices, and the like described herein have the necessary electronics, software, memory, storage, databases, firmware, logic/state machines, microprocessors, communication links, displays or other visual or audio user interfaces, printing devices, and any other I/O devices to provide any of the functions or services described herein and/or achieve the results described herein. Also, those of ordinary skill in the pertinent arts will recognize that users of such computers, servers, devices, and the like may operate a keyboard, keypad, mouse, stylus, touch screen, or other device (not shown) or method to interact with the computers, servers, devices, and the like, or to “select” an item, link, node, hub, or any other aspect of the present disclosure.

The aerial vehicle 101, the docking station 110, and/or the data processing system 1080 may use any web-enabled or Internet applications or features, or any other client-server applications or features including electronic mail (or E-mail), or other messaging techniques, to connect to the network 1090 or to communicate with one another, such as through short or multimedia messaging service (SMS or MMS) text messages, social network messages, online marketplace messages, telephone calls, or the like. For example, the aerial vehicle 101, the docking station 110, and/or the data processing system 1080 may be adapted to transmit information or data in the form of synchronous or asynchronous messages between or among themselves, or between or among any other computer device in real time or in near-real time, or in one or more offline processes, via the network 1090. Those of ordinary skill in the pertinent arts would recognize that the aerial vehicle 101, the docking station 110, and/or the data processing system 1080 may operate any of a number of computing devices that are capable of communicating over the network, including but not limited to set-top boxes, personal digital assistants, digital media players, web pads, desktop computers, laptop computers, tablet computers, smartphones, smart speakers, wrist watches, electronic book readers, and the like. The protocols and components for providing communication between such devices are well known to those skilled in the art of computer communications and need not be described in more detail herein.

The data and/or computer-executable instructions, programs, firmware, software, and the like (also referred to herein as “computer-executable” components) described herein may be stored on a computer-readable medium that is within or accessible by computers or computer components such as the processors 1012 and/or the data processing system 1080, or any other computers or control systems, and having sequences of instructions which, when executed by a processor (e.g., a central processing unit, or “CPU”), cause the processor to perform all or a portion of the functions, services, and/or methods described herein. Such computer-executable instructions, programs, software, and the like may be loaded into the memory of one or more computers using a drive mechanism associated with the computer readable medium, such as a floppy drive, CD-ROM drive, DVD-ROM drive, network interface, or the like, or via external connections.

Some embodiments of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, or other types of media/machine-readable medium that may be suitable for storing electronic instructions. Further, embodiments may also be provided as a computer-executable program product that includes a transitory machine-readable signal (in compressed or uncompressed form). Examples of machine-readable signals, whether modulated using a carrier or not, may include, but are not limited to, signals that a computer system or machine hosting or running a computer program can be configured to access, or including signals that may be downloaded through the Internet or other networks.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow charts shown in FIGS. 4 and 9, orders in which such methods or processes are presented are not intended to be construed as any limitation on the claimed inventions, and any number of the method or process steps or boxes described herein can be omitted, reordered, or combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. A system, comprising:
an aerial vehicle comprising a light source and an imaging sensor;
a docking station comprising a landing pad on an upper surface thereof, wherein a safety envelope defining a three-dimensional volume is configured to facilitate a docking evolution of the aerial vehicle with the docking station; and
a control system configured to at least:
instruct the aerial vehicle to initiate the docking evolution with the docking station;
instruct actuation of the light source to illuminate the landing pad;
instruct capture, using the imaging sensor, of imaging data of the landing pad;
determine a pose of the aerial vehicle relative to the docking station based on the imaging data;
determine a safety margin between the aerial vehicle and at least one boundary of the safety envelope based on the pose; and
instruct descent of the aerial vehicle during the docking evolution at a speed based on the safety margin.

2. The system of claim 1, wherein the light source is configured to emit light toward the docking station during the docking evolution; and
wherein the imaging sensor includes a field of view that extends toward the docking station during the docking evolution.

3. The system of claim 1, wherein the landing pad comprises a set of retroreflectors positioned around a periphery of the upper surface;
wherein the set of retroreflectors are configured to reflect light received from the light source; and
wherein the light reflected from the set of retroreflectors is detected by the imaging sensor at a first altitude from the docking station during an initial phase of the docking evolution.

4. The system of claim 3, wherein the landing pad further comprises a first set of indicia positioned on the upper surface and closer toward a center of the landing pad than the set of retroreflectors;
wherein the first set of indicia is detected by the imaging sensor at a second altitude from the docking station during an intermediate phase of the docking evolution; and
wherein the second altitude is less than the first altitude.

5. The system of claim 4, wherein the landing pad further comprises a second set of indicia positioned on the upper surface and substantially centered with respect to a position of the imaging sensor of the aerial vehicle upon completion of the docking evolution;
wherein the second set of indicia is detected by the imaging sensor at a third altitude from the docking station during a final phase of the docking evolution; and
wherein the third altitude is less than the first and second altitudes.

6. A method, comprising:
determining, by a control system associated with an aerial vehicle, a pose of the aerial vehicle relative to a docking station, wherein a safety envelope defining a volume is configured to facilitate docking of the aerial vehicle with the docking station;
determining, by the control system, a safety margin between the aerial vehicle and at least one boundary of the safety envelope; and
instructing, by the control system, descent of the aerial vehicle toward the docking station based at least in part on the safety margin.

7. The method of claim 6, wherein the pose comprises a horizontal position of the aerial vehicle relative to a vertical axis that extends through a center of the docking station; and
wherein the pose comprises a vertical altitude of the aerial vehicle relative to an upper surface of the docking station.

8. The method of claim 6, wherein the safety envelope comprises a three-dimensional volume having a plurality of boundaries that define the three-dimensional volume, the plurality of boundaries including the at least one boundary.

9. The method of claim 6, wherein the safety margin comprises a shortest distance between the at least one boundary and a portion of the aerial vehicle closest to the at least one boundary.

10. The method of claim 6, wherein the descent of the aerial vehicle is instructed at a first speed responsive to the safety margin being a maximum distance within a threshold; and
wherein the first speed is a maximum descent speed.

11. The method of claim 6, wherein the descent of the aerial vehicle is instructed at a second speed responsive to the safety margin being a second distance between a zero distance and a maximum distance; and
wherein the second speed is between a hover speed and a maximum descent speed based on the second distance.

12. The method of claim 6, wherein the descent of the aerial vehicle is instructed at a third speed responsive to the safety margin being a zero distance within a threshold; and
wherein the third speed is a hover speed.

13. The method of claim 6, wherein the descent of the aerial vehicle is instructed at a fourth speed responsive to the safety margin being a negative distance associated with a portion of the aerial vehicle extending outside the at least one boundary of the safety envelope; and
wherein the fourth speed is between a hover speed and a maximum ascent speed based on the negative distance.

14. The method of claim 6, wherein determining the pose of the aerial vehicle further comprises:
detecting, by an imaging sensor of the aerial vehicle, a landing pad positioned on an upper surface of the docking station; and
processing, by the control system, imaging data including representations of portions of the landing pad to determine the pose of the aerial vehicle.

15. The method of claim 14, wherein detecting the landing pad further comprises:
detecting, by the imaging sensor, at least one of a set of retroreflectors or a set of indicia positioned on the upper surface of the docking station;
wherein the upper surface of the landing pad comprises the set of retroreflectors and a plurality of sets of indicia, individual sets of the plurality of sets of indicia configured to be detected by the imaging sensor at different respective altitudes from the upper surface of the docking station.

16. A system, comprising:
a processor; and
a memory having executable instructions stored thereon, which when executed by the processor, cause the processor to at least:
determine a pose of an aerial vehicle relative to a docking station, wherein a safety envelope defining a volume is configured to facilitate docking of the aerial vehicle with the docking station;
determine a safety margin between the aerial vehicle and at least one boundary of the safety envelope; and
instruct descent of the aerial vehicle toward the docking station based at least in part on the safety margin.

17. The system of claim 16, wherein the pose of the aerial vehicle comprises a four degree of freedom pose of the aerial vehicle relative to the docking station during a docking evolution; and
wherein the safety envelope comprises a three-dimensional volume having a plurality of boundaries within which the aerial vehicle is instructed to operate during the docking evolution.

18. The system of claim 17, wherein the safety margin comprises a shortest distance between any of the plurality of boundaries and any portion of the aerial vehicle closest to respective ones of the plurality of boundaries.

19. The system of claim 16, wherein the safety margin comprises at least one of a current safety margin or a predicted safety margin.

20. The system of claim 17, wherein the descent of the aerial vehicle is instructed according to a control strategy that prioritizes:
descent speed toward the docking station responsive to all portions of the aerial vehicle remaining within the plurality of boundaries during the docking evolution; and
horizontal positioning over the docking station responsive to at least one portion of the aerial vehicle extending outside at least one of the plurality of boundaries.
